(19) United States
(12) Patent Application Publication
(10) Pub. No.: US 2026/0178292 A1
(43) Pub. Date: Jun. 25, 2026

(54) SCREEN CREATION DEVICE AND SCREEN CREATION METHOD

(71) Applicant: FANUC CORPORATION, Minamitsuru-gun, Yamanashi (JP)

(72) Inventor: Nobuhiro HARA, Yamanashi (JP)

(21) Appl. No.: 19/125,032

(22) PCT Filed: Nov. 29, 2022
(86) PCT No.: PCT/JP2022/043891

§ 371 Date: Apr. 28, 2025

(51) Int. Cl. G06F 8/38; G06F 3/0482

(52) U.S. Cl. CPC G06F 8/38; G06F 3/0482

(57) ABSTRACT

With the present invention it is possible to present, to a template creator, a screen that includes the most suitable configuration items corresponding to a method for using of the template screen, and to enable a screen creator, who will employ a template to create (customize) a display screen, to easily create a screen suited to work sites by configuring the template screen. This screen creation device comprises: a configuration-screen auto-creation unit for creating a configuration screen for the purpose of configuring configuration items each defined in pre-created display screen template information; a configuration-information creation unit for creating configuration information on the basis of the information for each of the configuration items configured on the configuration screen; and a screen auto-creation unit for creating the display screen on the basis of the template information and the configuration information created by the configuration-information creation unit.

### TECHNICAL FIELD

The present invention is related to a screen creation device and a screen creation method for creating a screen related to manufacturing, in accordance with each work site.

### BACKGROUND ART

Conventionally, techniques are known (e.g., Business Intelligence (BI) tools and Supervisory Control And Data Acquisition (SCADA)) by which a user can generate a work-specific screen based on a pre-created template screen, by customizing the template screen.

In addition, another conventional technique is known by which information or data that a user wishes to check can be displayed on a screen while being laid out with a certain degree of freedom. See Patent Document 1, for example.

Further, regarding a display item and a display size selected by a worker, while a plurality of segmented screens corresponding to the display size are displayed on a screen based on display information of a segmented screen storage region, a technique is known by which, when the worker designates one segmented screen from among the plurality of segmented screens displayed on the screen, a configuration of the display screen is freely customized in accordance with an intention of the worker who stores the display size and segmented screen position information of the designated segmented screen into a customized screen storage region. See Patent Document 2, for example.

### CITATION LIST

### Patent Document

Patent Document 1: Japanese Unexamined Patent Application, Publication No. 2000-066709
Patent Document 2: Japanese Unexamined Patent Application, Publication No. 2010-152882

### DISCLOSURE OF THE INVENTION

### Problems to be Solved by the Invention

However, according to the inventions disclosed in Patent Documents 1 and 2, when a template of the screen is applied to a work site, customization corresponding to gaps among different work sites and needs specific to certain users is required. Thus, a general-purpose template would make jobs complicated at the time of the application to each work site. In addition, templates specialized in a certain work site or equipment would have a problem where the purpose of use would be limited.

To cope with the circumstances described above, there is a demand for the capability to present, to a template creator, a screen that includes the most suitable configuration items corresponding to a method for using a template screen and enabling a screen creator, who will employ a template to create (customize) a display screen, to easily create a screen suited to each work site by configuring the template screen.

### Means for Solving the Problems

An aspect of a screen creation device of the present disclosure includes: a configuration-screen auto-creation unit configured to create a configuration screen for configuring each of configuration items defined in pre-created template information for a display screen; a configuration-information creation unit configured to create configuration information based on information for each of the configuration items configured on the configuration screen; and a screen auto-creation unit configured to create the display screen based on the template information and the configuration information created by the configuration-information creation unit,

An aspect of a screen creation method of the present disclosure provides a screen creation method that is for causing a computer to function as a screen creation device and includes: a selection step of selecting one of pieces of pre-created template information for a display screen; a configuration-screen auto-creation step of creating a configuration screen for configuring each of configuration items defined in the template information selected; a configuration-information creation step of creating configuration information based on information for each of the configuration items configured on the configuration screen; and a screen auto-creation step of creating the display screen based on the template information selected and the configuration information created.

### BRIEF DESCRIPTION OF THE DRAWINGS

FIG. 1 is a functional block diagram of a screen creation system according to an embodiment;

FIG. 2 is a drawing showing an example of an equipment state table;

FIG. 3 is a drawing showing an example of template information;

FIG. 4 is a drawing showing an example of a template screen in template information on a factory monitoring screen;

FIG. 5 is a drawing showing examples of appearances/behaviors in configuration items in the template information on the factory monitoring screen;

FIG. 6 is a drawing showing an example of usage data in the configuration items in the template information on the factory monitoring screen;

FIG. 7 is a drawing showing an example of a template screen in template information on a production performance registration screen;

FIG. 8 is a drawing showing examples of appearances/behaviors in configuration items in the template information on the production performance registration screen;

FIG. 9 is a drawing showing an example of usage data in the configuration items in the template information on the production performance registration screen;

FIG. 10 is a drawing showing an example of configuration information;

FIG. 11 is a drawing showing an example of a creation screen for the template information;

FIG. 12 is a drawing showing an example of meta information in a data source;

FIG. 13 is a drawing showing an example of meta information of equipment;

FIG. 14A is a drawing showing an example of a screen management screen;

FIG. 14B is a drawing showing an example of a template selection screen;

FIG. 15 is a drawing showing an example of a configuration screen for the factory monitoring screen;

FIG. 16 is a drawing showing an example of a configuration screen observed upon selecting an equipment icon (a constituent element);

FIG. 17 is a drawing showing another example of the configuration screen observed upon selecting the equipment icon (the constituent element);

FIG. 18 is a drawing showing yet another example of the configuration screen observed upon selecting the equipment icon (the constituent element);

FIG. 19 is a drawing showing an example of a configuration screen for the production performance registration screen;

FIG. 20 is a drawing showing an example of a configuration screen configured with a workpiece master;

FIG. 21 is a drawing showing an example of a configuration screen observed when a production performance registration has been selected, and a production performance table has been configured;

FIG. 22 is a drawing showing an example of a configuration screen observed when a production performance table has been configured, and input items have been selected;

FIG. 23 is a drawing showing another example of the configuration screen observed when a production performance table has been configured, and input items have been selected;

FIG. 24 is a drawing showing an example of configuration information for the production performance registration screen that has been updated;

FIG. 25 is a flowchart for explaining a creation process performed by a screen creation device, when configuration information is to be newly created;

FIG. 26 is a flowchart for explaining a creation process performed by the screen creation device, when existing configuration information is to be edited; and

FIG. 27 is a flowchart for explaining a creation process performed by the screen creation device, when a work screen is to be displayed by selecting configuration information.

### PREFERRED MODE FOR CARRYING OUT THE INVENTION

The following will describe an embodiment of the present disclosure, with reference to the drawings,

### Embodiment

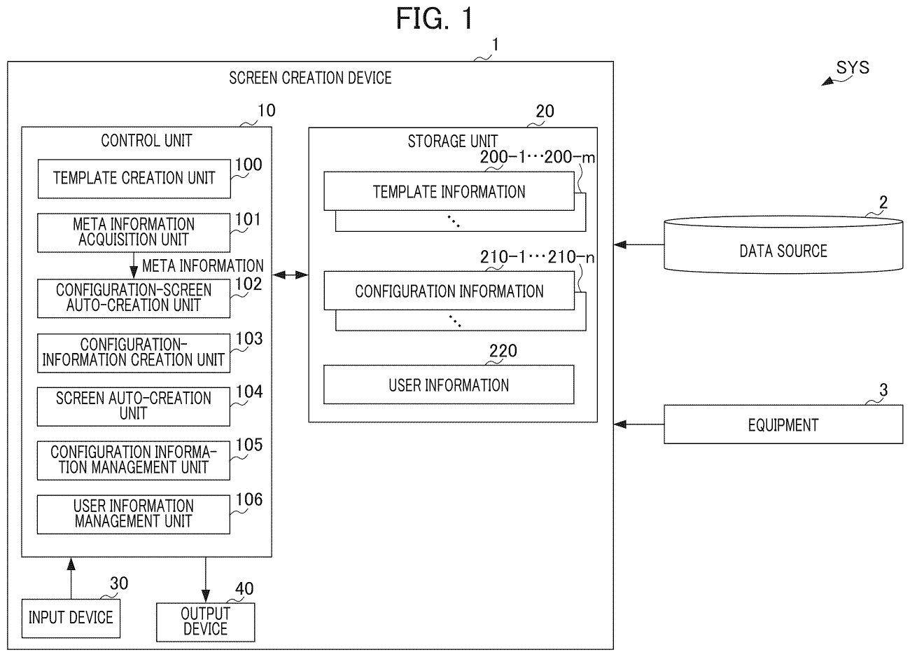

FIG. 1 is a functional block diagram of a screen creation system according to an embodiment.

As shown in FIG. 1, a screen creation system SYS includes a screen creation device 1, a data source 2, and equipment 3.

The screen creation device 1, the data source 2, and the equipment 3 may be connected to one another via a network (not shown) such as a Local Area Network (LAN) or the Internet. In that situation, the screen creation device 1, the data source 2, and the equipment 3 may each include a communication unit (not shown) for communicating with one another through such connections. Further, the screen creation device 1, the data source 2, and the equipment 3 may directly be connected to one another via a connection interface (not shown) in a wired or wireless manner.

Further, although being connected to the one data source 2 and the one piece of equipment 3 in FIG. 1, the screen creation device 1 may be connected to two or more data sources 2 and two or more pieces of equipment 3.

### <Data Source 2>

The data source 2 may be a data server, a cloud server, or the like, for example, and has stored therein data such as an equipment state table and a production performance table indicating information about the equipment 3 provided at each work site such as a factory.

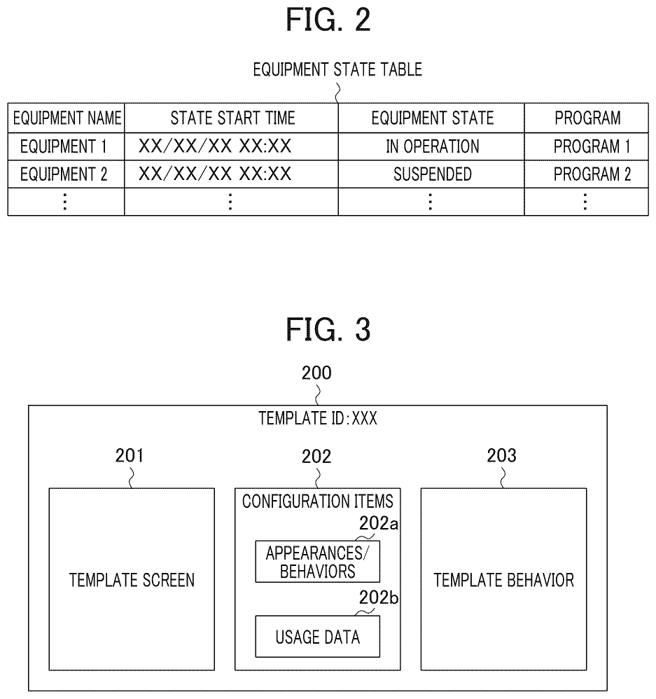

FIG. 2 is a drawing showing an example of the equipment state table.

As shown in FIG. 2, the equipment state table has, for example, storage regions for “equipment name”, “state start time”, “equipment state”, and “program”.

The storage region for the “equipment name” in the equipment state table stores therein, for example, equipment such as “Equipment 1” and “Equipment 2”.

The storage region for the “state start time” in the equipment state table stores therein, for example, the start date/times at each of which the equipment state became the current state.

The storage region for the “equipment state” in the equipment state table stores therein, for example, information indicating the current state such as “in operation” or “suspended”, with respect to each of the pieces of equipment corresponding to the “equipment name”.

The storage region for the “program” in the equipment state table stores therein, for example, a program that is currently executed or was most recently executed, such as “Program 1”, or “Program 2”, with respect to each of the pieces of equipment corresponding to the “equipment name”

Further, the data source 2 may store therein the production performance table (which may include, for example, workpiece IDs, equipment names, step names, beginning times, completion times, etc.).

### <Equipment 3>

The equipment 3 may be a numerical control device, a robot control device, a machine tool, a robot, or the like provided at the work site such as the factory. The equipment 3 has stored therein data such as an executable function list indicating executable functions. The equipment 3 outputs data such as the executable function list, together with an equipment state indicating the current state or the like, to the screen creation device 1 and to the data source 2.

### <Screen Creation Device 1>

The screen creation device 1 may be, for example, a web server, a cloud server, a virtual server, or the like and may mutually be connected with a display device (not shown) of a computer or the like displaying a screen related to manufacturing, via a network (not shown) such as a LAN or the Internet.

In this situation, as the screen related to the manufacturing, examples of a screen related to production include a factory monitoring screen, an equipment state checking screen, an Overall Equipment Effectiveness (OEE) checking screen, and a screen for recording beginning and completion of steps. Examples of a screen related to maintenance of the equipment include a screen registering an actual performance of maintenance, a screen for registering a maintenance plan, and a screen used for referencing a history of maintenance. Examples of a screen related to quality of a product include a screen for registering a measurement result of the product and a screen used for understanding a tendency in measurement results of the product. However, possible embodiments are not limited to these examples. The present disclosure is applicable to any screen related to manufacturing.

As explained above, the screen created by the screen creation device 1 is applied to the display device (not shown) as described below. The display device (not shown) displays, on a display unit (not shown) such as a liquid crystal display, for example, the screen created by the screen creation device 1, so as to display the screen related to the manufacturing. In this situation, the screen creation device 1 may mutually be connected directly with the display device (not shown), via a connection interface (not shown).

Further, although being a device different from the display device (not shown) as explained later, the screen creation device 1 may be structured so as to include the display device (not shown).

As shown in FIG. 1, the screen creation device 1 includes: a control unit 10, a storage unit 20, an input device 30 such as a keyboard, a mouse, a touch panel, and/or the like, and an output device 40 such as a liquid crystal display. Further, the control unit 10 includes a template creation unit 100, a meta information acquisition unit 101, a configuration-screen auto-creation unit 102, a configuration-information creation unit 103, a screen auto-creation unit 104, a configuration information management unit 105, and a user information management unit 106.

### <Storage Unit 20>

The storage unit 20 may be a Solid State Drive (SSD), a Hard Disk Drive (HDD), or the like. Together with an operating system, an application program, and the like executed by the control unit 10, the storage unit 20 has stored therein m pieces of template information 200-1 to 200-m and n pieces of configuration information 210-1 to 210-n, and user information 220 (where m and n each denote an integer being 1 or larger),

In the following sections, when there is no need to be individually distinguished, the pieces of template information 200-1 to 200-m may collectively be referred to as “template information 200”. Also, when there is no need to be individually distinguished, the pieces of configuration information 210-1 to 210-n may collectively be referred to as “configuration information 210”.

For example, the template information 200 is information that is for creating a display screen (which hereinafter may be referred to as a “work screen”) and is pre-created by the template creation unit 100 (explained later) based on an operation performed by a template creator. As shown in FIG. 3, the template information 200 includes a template ID defined in advance by the template creator, a template screen 201, configuration items 202, and a template behavior 203. Further, the configuration items 202 include, as explained later, appearances/behaviors 202a and usage data 202b, due to differences in accompaniment information and configuration screens to be used for establishing configurations.

The template ID is an identifier for uniquely identifying the template information 200 and may be configured, for example, with characters, numerals, or a combination of the two, such as “XXX”.

The following will explain examples of the template screen 201, the configuration items 202, and the template behavior 203, in the situations where the template information 200 (a) is the factory monitoring screen and (b) is a production performance registration screen. It should be noted, however, the template screen 201, the configuration items 202, and the template behavior 203 on screens other than the factory monitoring screen and the production performance registration screen are also the same as those on the factory monitoring screen and the production performance registration Screen.

### (a) an Example of the Factory Monitoring Screen

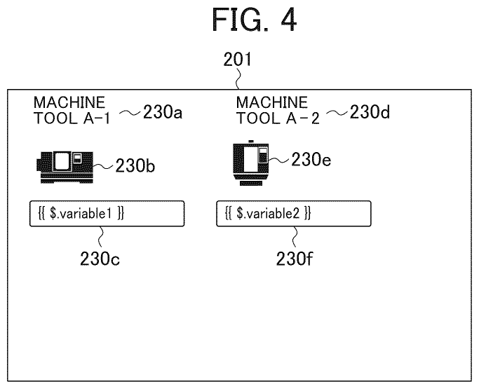

FIG. 4 is a drawing showing an example of the template screen 201 in the template information 200 on the factory monitoring screen.

As shown in FIG. 4, the template screen 201 is configured, for example, with six constituent elements 230a to 230f. The constituent elements 230a and 230d are each configured with text for displaying an equipment name. The constituent elements 230b and 230e are each configured with an equipment icon representing the corresponding equipment 3. The constituent elements 230c and 230f are each configured, for example, with a text box used for displaying the name of a workpiece manufactured by the corresponding equipment.

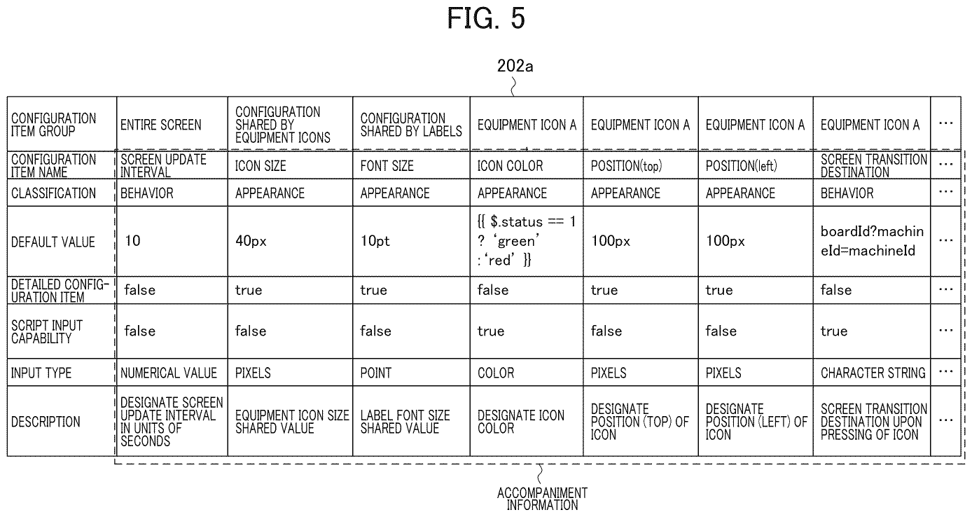

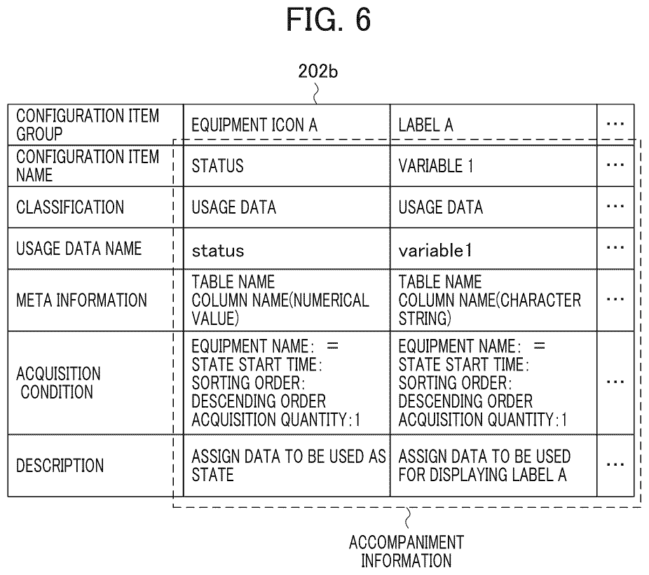

FIG. 5 is a drawing showing examples of the appearances/behaviors 202a in the configuration items 202 in the template information 200 on the factory monitoring screen. FIG. 5 shows the appearances/behaviors 202a in the configuration items 202 for the constituent element 230b (an equipment icon A) among the constituent elements 230a to 230f on the template screen 201. As shown in FIG. 5, the appearances/behaviors 202a in the configuration items 202 for the constituent element 230b may include the accompaniment information. Further, the configuration items 202 do not necessarily need to correspond to one of the constituent elements on the template screen 201. For example, it is possible to provide the configuration items in necessary units such as those related to the entirety of the template screen or those commonly related to a plurality of constituent elements.

In other words, the appearances/behaviors 202a for the constituent element 230b has configuration item groups such as “entire screen”, “configuration shared by equipment icons”, “configuration shared by labels”, and four “equipment icons A”, and the like. Further, the appearances/behaviors 202a include the accompaniment information corresponding to each of the configuration item groups such as “entire screen”, “configuration shared by equipment icons”, “configuration shared by labels”, and the four “equipment icons A” to the items enclosed in the broken-line box on the second line and thereafter. The accompaniment information of the appearances/behaviors 202a includes items such as “configuration item name”, “classification”, “default value”, “detailed configuration item”, “script input capability”, “input type”, and “description”. These pieces of accompaniment information serve as a type of configuration conditions for the appearances/behaviors 202a.

A storage region for the “configuration item name” in the accompaniment information stores therein a name for identifying a corresponding one of the configuration items with respect to each of the configuration item groups included in the appearances/behaviors 202a. In the accompaniment information in FIG. 5, with respect to each of the configuration item groups such as the “entire screen”, the “configuration shared by the equipment icons”, the “configuration shared by the labels”, and the four “equipment icons A”, configuration values such as a “screen update interval”, an “icon size”, a “font size”, an “icon color”, a “position (top)”, a “position (left)”, a “screen transition destination”, or the like are stored.

The storage region for the “classification” in the accompaniment information stores therein classifications of the appearances/behaviors 202a. In the accompaniment information in FIG. 5, with respect to each of the configuration item groups such as the “entire screen”, the “configuration shared by equipment icons”, the “configuration shared by labels”, and the four “equipment icons A”, either “behavior” or “appearance” is stored.

The storage region for the “default value” in the accompaniment information stores therein initial values of the appearances/behaviors 202a. In the accompaniment information in FIG. 5, with respect to each of the configuration item groups such as the “entire screen”, the “configuration shared by equipment icons”, the “configuration shared by labels”, and the four “equipment icons A”, the following is stored: “10”, “40 px”, “10 pt” “{{$.status==1 ? ‘green’:‘red’}}”, “100 px”, “100 px”, or “boardId?machineId=machineId”. In this situation “10” indicates that a screen update interval is ten seconds. Further, “40 px” indicates that the icon size of the equipment icon is 40 pixels. Further, “10 pt” indicates that the font size of the label is 10 points. Further, “{{$.status==1? ‘green’:‘red’}}” is written in JavaScript (registered trademark), for example, and indicates that when the variable “status” configured in the data is equal to “1”, the equipment icon is colored “green”, and otherwise the equipment icon is colored “red”. Further, the “100 px” indicates the coordinates at the top and at the left where the equipment icon A serving as the constituent element 230b on the work screen is positioned. Further, “boardId?machineId=machineId” indicates a screen transition destination to be used when the equipment icon A is pressed.

The storage region for the “detailed configuration item” in the accompaniment information stores therein whether the configuration item is to be displayed (true) or is not to be displayed (false), as a detailed configuration being a configuration item having low change frequency, on the configuration screen used for the purpose of configuring the configuration item. In the accompaniment information in FIG. 5, either “false” or “true” is stored with respect to each of the configuration item groups such as the “entire screen”, the “configuration shared by the equipment icons”, the “configuration shared by the labels”, and the four “equipment icons A”.

The storage region for the “script input capability” in the accompaniment information stores therein whether a script is configurable (true) or is not configurable (false) as a configuration value. In the accompaniment information in FIG. 5, either “false” or “true” is stored with respect to each of the configuration item groups such as the “entire screen” in the “configuration shared by the equipment icons”, the “configuration shared by the labels”, and the four “equipment icons A”.

The storage region for the “input types” in the accompaniment information stores therein the types of the data for the configuration values. In the accompaniment information in FIG. 5, with respect to each of the configuration item groups such as the “entire screen”, the “configuration shared by the equipment icons”, the “configuration shared by the labels”, and the four “equipment icons A”, the following is stored: “numerical value”, “pixels”, “point”, “color”, “pixels”, “pixels”, or “character string”.

The storage region for the “description” in the accompaniment information stores therein description for informing a screen creator of meanings of the configuration item names.

FIG. 6 is a drawing showing an example of the usage data 202b in the configuration items 202 in the template information 200 on the factory monitoring screen. FIG. 6 shows the usage data 202b in the configuration items 202 corresponding to the constituent element 230b (the equipment icon A) and to the constituent element 230c (the label A), among the constituent elements 230a to 230f on the template screen 201. In this situation, the usage data 202b of the constituent elements 230a and 230d to 230f are the same as the examples with the constituent element 230b and the constituent element 230c, and thus explanations thereof will be omitted. As shown in FIG. 6, the usage data 202b in the configuration items 202 corresponding to the constituent element 230b and the constituent element 230c may include the accompaniment information.

In other words, the usage data 202b corresponding to the constituent element 230b and the constituent element 230c include the configuration item groups such as the “equipment icon A”, the “label A”, and the like. Further, the usage data 202b includes the items enclosed in the broken-line box on the second line and thereafter, as the accompaniment information corresponding to each of the configuration item groups such as the “equipment icon A” and the “label A”, while including items such as “configuration item name”, “classification”, “usage data name”, “meta information”, “acquisition condition”, and “description”. These pieces of accompaniment information serve as a type of configuration conditions for the usage data 202b.

The storage region for the “configuration item name” in the accompaniment information stores therein, with respect to each of the configuration item groups included in the usage data 202b, a configuration value indicating whether the data represents a status or a specific variable. In the accompaniment information in FIG. 6, with respect to each of the configuration item groups such as the “equipment icon A” and the “label A”, the following configuration value is stored: “status”, “variable 1”, or the like.

The storage region for the “classifications” in the accompaniment information stores therein classifications of the usage data 202b. In the accompaniment information in FIG. 6, with respect to each of the configuration item groups such as “equipment icon A”, and the “label A”, “usage data” is stored.

The storage region for the “usage data name” in the accompaniment information stores therein a usage data variable name such as “status” or “variable 1”, with respect to each of the configuration item groups such as the “equipment icon A” and the “label A”.

The storage region for the “meta information” in the accompaniment information stores therein meta information of the usage data assigned to each of the configuration item groups such as the “equipment icon A” and the “label A”, based on meta information of the data stored in the data source 2, the equipment 3, and the like acquired by the meta information acquisition unit 101 (explained later).

The storage region for the “acquisition condition” in the accompaniment information stores therein a condition (e.g., a “equipment name”, a “state start time”, a “sorting order”, an “acquisition quantity”, etc.) and a default value (e.g., “=” “descending order”, “1”, etc.) to be used at the time of acquiring the usage data corresponding to each of the configuration item groups such as the “equipment icon A” and the “label A”.

The storage region for the “description” in the accompaniment information stores therein description for informing the screen creator of meanings of the configuration item names.

The template behavior 203 stores therein, for example, a source code such as a script for executing a process based on the configurations of the appearances/behaviors 202a and the usage data 202b. The source code of the template behavior 203 may include, for example, a code for updating the screen once every certain period of time (e.g., 10 seconds) configured as the “screen update interval” in the appearances/behaviors 202a. Further, the source code may include a code that acquires data from the meta information assigned to the “status” of the “equipment icon A” in the usage data 202b and that makes the acquired data usable as the usage data name “status”. Further, the source code may include a code that acquires data from the meta information assigned to the “variable 1” of the “label A” in the usage data 202b and that makes the acquired data usable as the usage data name “variable 1”. Furthermore, the source code may include a code that interprets (e.g., determines the icon is to be colored “green”, because the value of the “status” for the “equipment icon A” is “1”) a script of the configuration value of the appearances/behaviors 202a based on the usage data 202b or that displays the template screen 201 based on the configuration value.

The template information 200 in the example of the factory monitoring screen has thus been explained.

### (b) an Example of the Production Performance Registration Screen

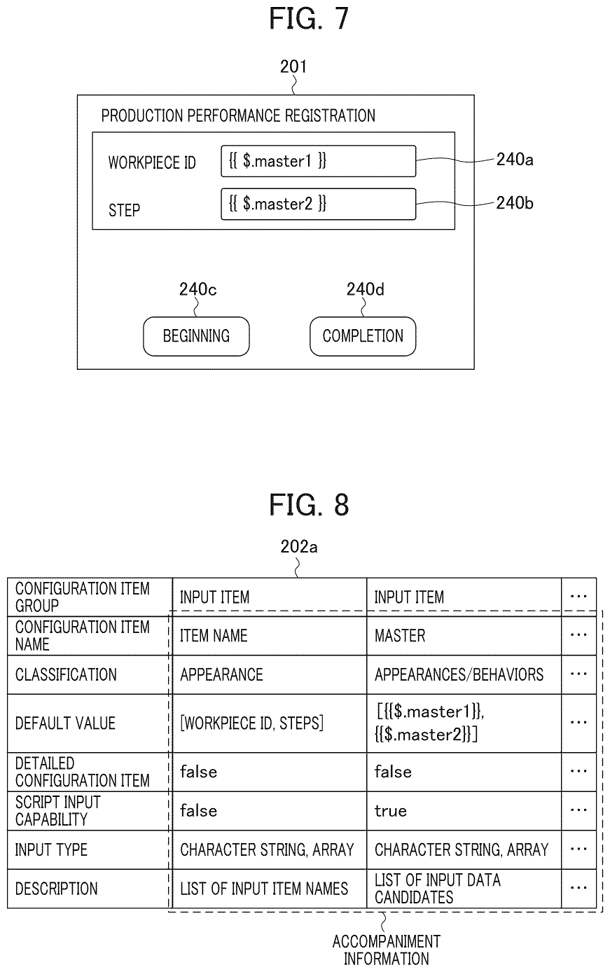

FIG. 7 is a drawing showing an example of the template screen 201 in the template information 200 on the production performance registration screen.

As shown in FIG. 7, the template screen 201 is configured, for example, with four constituent elements 240a to 240d. The constituent elements 240a and 240b are configured with text boxes for displaying a workpiece ID and a step. The constituent elements 240c and 240d are configured with buttons for acquiring a beginning time and a completion time of the step corresponding to the abovementioned workpiece ID.

FIG. 8 is a drawing showing examples of the appearances/behaviors 202a in the configuration items 202 in the template information 200 on the production performance registration screen. FIG. 8 shows the appearances/behaviors 202a in the configuration items 202 corresponding to the constituent elements 240a and 240b, among the constituent elements 240a to 240d on the template screen 201, As shown in FIG. 8, the appearances/behaviors 202a in the configuration items 202 corresponding to the constituent elements 240a and 240b may include accompaniment information.

In other words, the appearances/behaviors 202a corresponding to the constituent elements 240a and 240b include configuration item groups such as “input item”. Further, the appearances/behaviors 202a include the items enclosed in the broken-line box on the second line and thereafter, as the accompaniment information corresponding to each of the configuration item groups such as the two “input names”, while including the items such as “configuration item name”, “classification”, “default value”, “detailed configuration item”, “script input capability”, “input type” and “description”.

The storage region for the “configuration item names” in the accompaniment information stores therein, with respect to each of the configuration item groups included in the appearances/behaviors 202a, a name for identifying a corresponding one of the configuration items. In the accompaniment information in FIG. 8, with respect to each of the configuration item groups such as the two “input items”, a configuration value such as “item name” or “master” is stored.

The storage region for the “classification” in the accompaniment information stores therein classifications of the appearances/behaviors 202a. In the accompaniment information in FIG. 8, with respect to each of the configuration item groups such as the two “input items”, “appearance” or “appearance/behavior” is stored.

The storage region for the “default value” in the accompaniment information stores therein initial values of the appearances/behaviors 202a. In the accompaniment information in FIG. 8, with respect to each of the configuration item groups such as the two “input items”, the following is stored: “[workpiece ID, step]” or “{{$.master1}}, {{$.master2}}”. The notation “{{$.master1}}, {{$.master2}}” may be written in JavaScript (registered trademark), for example, and stores therein (displays) data corresponding to the meta information acquired by the meta information acquisition unit 101 (explained later).

The storage region for the “detailed configuration item” in the accompaniment information stores therein whether the configuration item is to be displayed (true) or is not to be displayed (false) as a detailed configuration being a configuration item having low change frequency, on the configuration screen used for the purpose of configuring the configuration item. In the accompaniment information in FIG. 8, with respect to each of the configuration item groups such as the two “input items”, either “false” or “true” is stored.

The storage region for the “script input capability” in the accompaniment information stores therein whether a script is configurable (true) or is not configurable (false) as a configuration value. In the accompaniment information in FIG. 8, with respect to each of the configuration item groups such as the two “input items”, either “false” or “true” is stored.

The storage region for the “input type” in the accompaniment information stores therein the types of the data for the configuration values. In the accompaniment information in FIG. 8, with respect to each of the configuration item groups such as the two “input items”, “character string, array” is stored.

The storage region for the “description” in the accompaniment information stores therein description for informing the screen creator of meanings of the configuration item names.

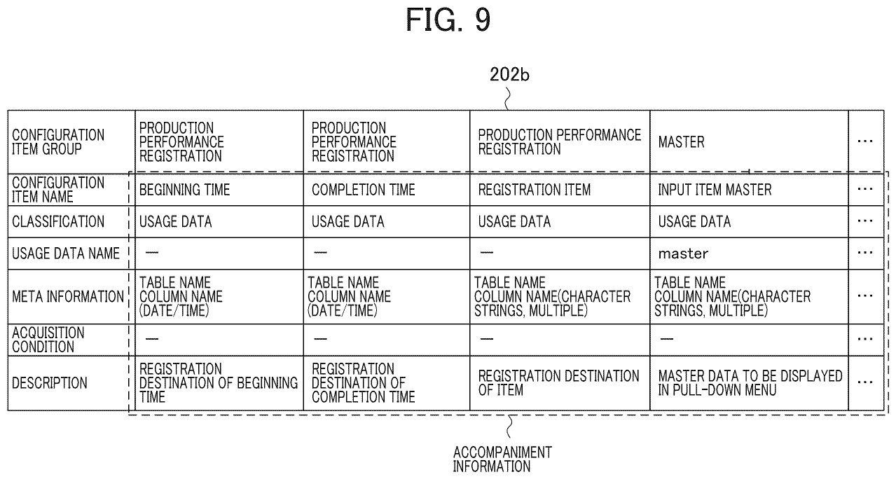

FIG. 9 is a drawing showing an example of the usage data 202b in the configuration items 202 in the template information 200 on the production performance registration screen. FIG. 9 shows the usage data 202b in the configuration items 202 corresponding to each of the constituent elements 240a and 240b, among the constituent elements 240a to 240d on the template screen 201. Because the usage data 202b of the constituent elements 240c and 240d are also the same as that of the constituent elements 240a and 240b, explanations thereof will be omitted. As shown in FIG. 9, the usage data 202b in the configuration items 202 corresponding to the constituent elements 240a and 240b may include accompaniment information.

In other words, the usage data 202b corresponding to the constituent elements 240a and 240b include configuration item groups such as “production performance registration”, “master”, and the like. Further, the usage data 202b includes the items enclosed in the broken-line box on the second line and thereafter, as the accompaniment information corresponding to each of the configuration item groups such as the three “production performance registrations” and the “master”, while including items such as “configuration item name” “classification”, “usage data name”, “meta information” “acquisition condition”, and “description”. These pieces of accompaniment information serve as a type of configuration conditions for the usage data 202b.

The storage region for the “configuration item name” in the accompaniment information stores therein, with respect to each of the configuration item groups included in the usage data 202b, a configuration value indicating what item is represented. In the accompaniment information in FIG. 9, with respect to each of the configuration item groups such as the three “production performance registrations” and the “master” the following configuration value is stored: “beginning time”, “completion time”, “registration item”, “input item master” or the like.

The storage region for the “classification” in the accompaniment information stores therein classifications of the usage data 202b. In the accompaniment information in FIG. 9, with respect to each of the configuration item groups such as the three “production performance registrations” and the “master”, “usage data” is stored.

The storage region for the “usage data name” in the accompaniment information stores therein a usage data variable name such as “− (blank)” or “master”, with respect to each of the configuration item groups in the usage data 202b such as the three “production performance registrations” and the “master”.

The storage region for the “meta information” in the accompaniment information stores therein meta information of the usage data assigned to each of the configuration item groups in the usage data 202b such as the three “production performance registrations” and the “master”, based on the meta information of the data stored in the data source 2, the equipment 3, and the like that was acquired by the meta information acquisition unit 101 (explained later) from the data source 2, the equipment 3, and the like.

The storage region for the “acquisition condition” in the accompaniment information store therein a condition to be used at the time of acquiring the usage data, with respect to each of the configuration item groups in the usage data 202b such as the three “production performance registrations” and the “master”. In the usage data 202b in FIG. 9, “− (blank)” is configured.

The storage region for the “description” in the accompaniment information stores therein description for informing the screen creator of meanings of the configuration item names.

The template behavior 203 on the production performance registration screen stores therein, for example, a source code such as a script to be used for executing a process based on the configurations of the appearances/behaviors 202a and the usage data 202b. The source code of the template behavior 203 may include, for example, a code for acquiring master data from the meta information assigned to the “input item master” of the appearances/behaviors 202a and setting the acquired master data into various types of pull-down menus. Further, the source code may include a code for newly registering data based on a current time and an input status, when the BEGINNING button serving as the constituent element 240c is pressed. Further, the source code may include a code for updating data based on a current time and an input status when the COMPLETION button serving as the constituent element 240d is pressed. Further, the source code may include a code for displaying an input interface (e.g., a workpiece, a step, equipment, etc.) in accordance with the configuration value of the input item.

The template information 200 in the example of the production performance registration screen has thus been explained.

Next, the configuration information 210 will be explained.

The configuration information 210 is created by the configuration-information creation unit 103 (explained later).

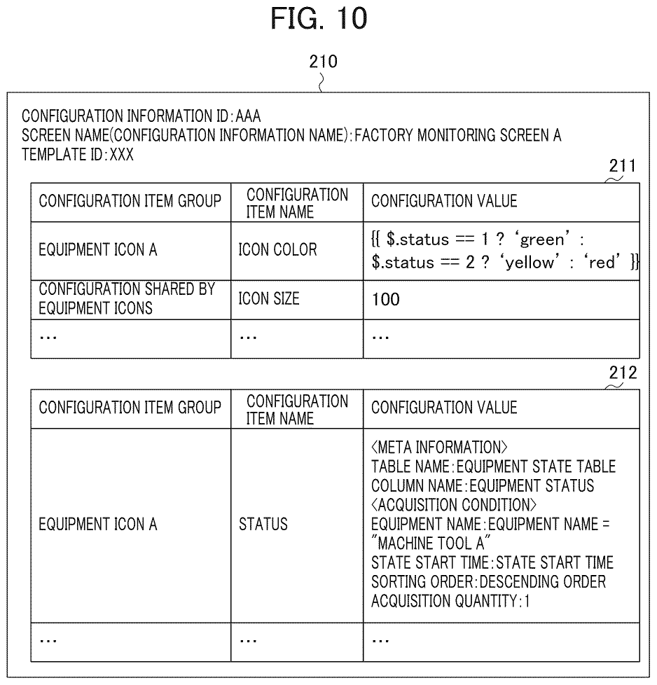

FIG. 10 is a drawing showing an example of the configuration information 210. In this situation, FIG. 10 shows an example of the configuration information 210 for the factory monitoring screen.

As shown in FIG. 10, the configuration information 210 includes a configuration information ID (an automatically-generated UUID or the like, if the configuration information was newly created) for identifying the configuration information 210, a screen name, and a template ID of the template information 200 to be used.

Further, as explained later, the configuration information 210 includes a table 211 storing therein a configuration item group of which the default value was changed by the screen creator among the appearances/behaviors 202a shown in FIG. 5, as well as a configuration item name and a post-change configuration value. Further, the configuration information 210 includes a table 212 storing therein a configuration item group of which the default value was changed by the screen creator among the usage data 202b shown in FIG. 6, as well as a configuration item name and a post-change configuration value.

The configuration information 210 has thus been explained.

Next, the user information 220 will be explained.

The user information 220 stores therein, in advance, information related to a user.

More specifically, the user information 220 may include, for example, a user ID, a full name, a phone number, an email address, and the like of the user, together with a current role, a department, a career number of years, and the like, Further, the user information 220 may include, as explained later, operation permission information on the work screen or the like.

### <Control Unit 10>

The control unit 10 includes a CPU, a ROM, a RAM, a CMOS memory, and the like. These elements are able to communicate with one another via a bus and are well known among persons skilled in the art.

The CPU is a processor that controls the entirety of the screen creation device 1. The CPU reads a system program and an application program stored in the ROM via the bus and controls the entirety of the screen creation device 1 in accordance with the system program and the application program. As a result, as shown in FIG. 1, the control unit 10 is structured so as to realize functions of the template creation unit 100, the meta information acquisition unit 101, the configuration-screen auto-creation unit 102, the configuration-information creation unit 103, the screen auto-creation unit 104, the configuration information management unit 105, and the user information management unit 106. The RAM stores therein various types of data such as temporary calculation data, display data, and the like. The CMOS memory is configured as a non-volatile memory that is backed up by a battery (not shown) and that holds a storage state even when the electrical power supply of the screen creation device 1 is turned off.

Although the present embodiment uses the example in which the screen creation device 1 includes the template creation unit 100, possible embodiments are not limited to this example. The template creation unit 100 may be structured as a template creation device (not shown) being a different device from the screen creation device 1. In other words, the template creator is able to create the template information 200 by using the template creation device (not shown) and to further provide the created template information 200 to a large number of users.

Before explaining, in detail, each of the functions such as the template creation unit 100, the meta information acquisition unit 101, the configuration-screen auto-creation unit 102, the configuration-information creation unit 103, the screen auto-creation unit 104, the configuration information management unit 105, and the user information management unit 106, we will explain an outline of an operation of each of the functions.

The template creation unit 100 creates the template information 200 corresponding to the functions of the equipment or the work site such as a factory, based on an input operation performed by the template creator via the input device 30 and further stores the created template information 200 into the storage unit 20.

The meta information acquisition unit 101 acquires the meta information of the data stored in the data source 2, the equipment 3, and the like, from the data source 2, the equipment 3, and the like and further outputs the acquired meta information to a configuration screen created by the configuration-screen auto-creation unit 102.

The configuration-screen auto-creation unit 102 reads, from the storage unit 20, the template information 200 selected by the screen creator who generates (customizes) a work screen and further creates the configuration screen for creating the configuration information 210 related to the configuration item with respect to the entire screen or each of the constituent elements (e.g., the constituent elements 230a to 230f) on the screen, based on the appearances/behaviors 202a and the usage data 202b in the configuration items 202 defined in advance in the read template information 200. Further, when the screen creator has selected existing configuration information 210, the configuration-screen auto-creation unit 102 may read, from the storage unit 20, the template information 200 associated with the selected configuration information 210. The configuration-screen auto-creation unit 102 may create a configuration screen for editing (customizing) the selected configuration information 210, based on the appearances/behaviors 202a and the usage data 202b in the configuration items 202 defined in advance in the read template information 200 and the configuration information 210.

The configuration-information creation unit 103 creates the configuration information 210, based on the configuration value configured or edited by the screen creator on the configuration screen created by the configuration-screen auto-creation unit 102 and further stores the created configuration information 210 into the storage unit 20.

The screen auto-creation unit 104 creates the work screen serving as a screen related to manufacturing, based on the configuration information 210 selected according to an input operation performed by a screen user and the template information 200 associated with the selected configuration information 210 and further causes the created work screen to be displayed on a display device (not shown).

The configuration information management unit 105 manages the configuration information 210 created by the configuration-information creation unit 103, based on the configuration information ID with which the configuration information 210 is configured.

The user information management unit 106 manages the user information 220, with respect to each of the users such as the template creator, the screen creator, and the screen user.

### <Template Creation Unit 100>

The template creation unit 100 creates the template information 200 corresponding to the functions of the equipment 3 or the work site such as a factory, based on an input operation performed by the template creator via the input device 30 and further stores the created template information 200 into the storage unit 20.

More specifically, for example, upon receipt of an instruction to create the template information 200 according to the input operation performed by the template creator, the template creation unit 100 displays a creation screen 300 for the template information 200 on the output device 40.

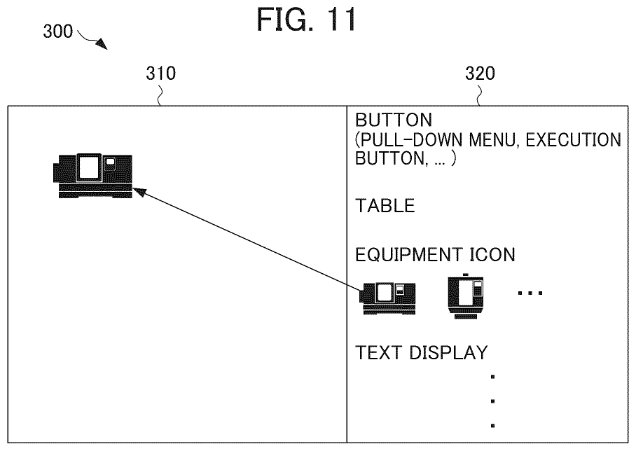

FIG. 11 is a drawing showing an example of the creation screen 300 for the template information 200.

As shown in FIG. 11, the creation screen 300 includes a template screen configuration region 310 and a constituent element list 320. In this situation, the constituent element list 320 includes, as constituent elements, buttons (e.g., a pull-down menu, an execution button, etc.), a table, an equipment icon, a text display, and/or the like, for example. Further, each of the constituent elements may be configured with the appearances/behaviors 202a and the usage data 202b in the configuration items 202 that are default for the constituent element.

For example, as shown in FIG. 11, the template creation unit 100 drags and drops the equipment icon according to an input operation performed by the template creator and arranges and determines the equipment icon in a desired position. In addition, with respect to the constituent elements 230a and 230c to 230f also, the template creation unit 100 similarly drags and drops so as to arrange and determine an equipment icon, a text display, or the like in a desired position, according to an input operation performed by the template creator. As a result, the template creation unit 100 is able to create the template screen 201 shown in FIG. 4 or the like.

After the constituent elements such as the equipment icon and the arrangement positions thereof have been determined, the template creation unit 100 automatically creates the template screen 201, the appearances/behaviors 202a and the usage data 202b in the configuration items 202, and the source code of the template behavior 203, based on the types and the arrangement positions of the constituent elements. In this situation, based on an input by the template creator, the template creation unit 100 may edit the source code of the template behavior 203 (e.g., adding a template behavior or adding a configuration item that is not associated with a constituent element). Further, based on an input operation performed by the template creator, the template creation unit 100 may create or correct (e.g., adjusting a configuration item) the appearances/behaviors 202a and the usage data 202b in the configuration items 202 corresponding to a constituent element, as necessary. Further, the template creation unit 100 may create new template information 200, based on the existing template information 200. Furthermore, the template creation unit 100 may have built therein a debug function for the template information 200. In addition, based on an operation performed by the template creator, the template creation unit 100 may configure the template information 200 with usage permission information about users to whom the usage (the use) of the template information 200 is permitted and/or edit permission information about users to whom editing of the template information 200 is permitted.

The template creation unit 100 stores, into the storage unit 20, data including the template screen 201 configured in the template screen configuration region 310, the appearances/behaviors 202a and the usage data 202b in the configuration items 202, and the template behavior 203, as the template information 200.

### <Meta Information Acquisition Unit 101>

The meta information acquisition unit 101 acquires the meta information of the data stored in the data source 2, the equipment 3, and the like, from the data source 2, the equipment 3, and the like, and further outputs the acquired meta information to the configuration-screen auto-creation unit 102.

More specifically, for example, the meta information acquisition unit 101 acquired and has registered therein, in advance, meta data (e.g., an equipment name, a model number name, the name of a person in charge, state start time information, equipment state information, a program name, etc.) related to the equipment at each work site such as a factory and stored in the data source 2, as well as meta data (an equipment name, a function name, etc.) related to the equipment and stored in the equipment 3. In this situation, the equipment 3 may have registered therein, in advance, a list of functions executable by the equipment 3, together with a registration of connection information (e.g., an IP address) of the equipment 3 which is desired to be configured at each work site. Further, connection destination information (e.g., an IP address and a password, etc.) of a database may be registered in advance, so that the meta information acquisition unit 101 acquires the meta information by executing a query.

Further, the meta information acquisition unit 101 may utilize a meta information acquisition function of the equipment or software (e.g., an interface called Remote Procedure Call (RPC) for invoking a function, etc.) used for communicating with the equipment, which is provided for an Internet of Things (IoT) platform. In that situation, it is desirable to configure the IoT platform to publish a document for users, so as to indicate what type of meta information (the interface (the RPC) used for invoking the function) is held by the equipment or the software (a converter) used for communicating with the equipment. With this arrangement, the template creator is able to create the accompaniment information (the configuration conditions) for the appearances/behaviors 202a and the usage data 202b in the configuration items 202, after understanding, in advance, the functions held by the equipment.

Further, in the situation where the IoT platform defines shared meta information (an interface) with respect to shared functions (e.g., transmitting a file, acquiring a file, acquiring a list of files, deleting a file, configuring a variable, acquiring a variable, etc.) regardless of the equipment, so as to use equipment or software that communicates with the equipment corresponding to the shared functions, the template creator is able to create the accompaniment information (the configuration conditions) for the appearances/behaviors 202a and the usage data 202b in the configuration items 202, without being conscious about the equipment.

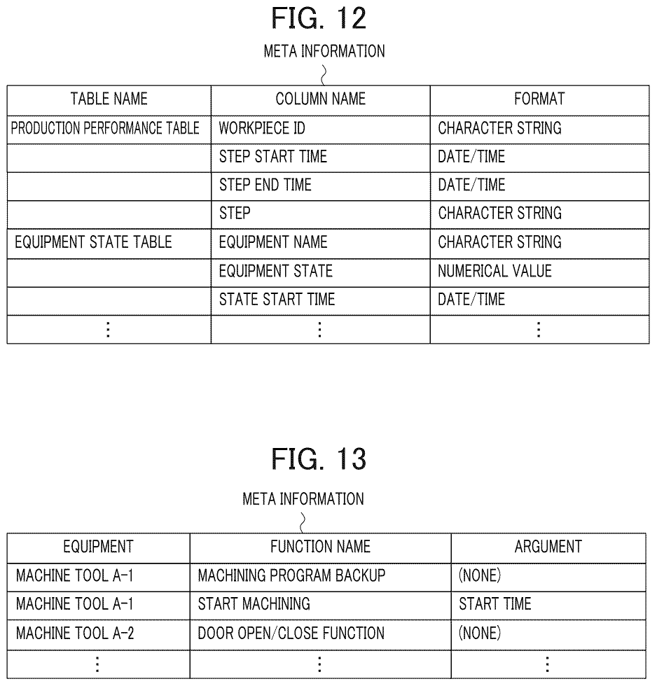

For example, when the data source 2 is a database, the meta information acquisition unit 101 acquires, from the data source 2, a list of tables, and a list of column names and formats for each of the tables, as the meta information of the data, as shown in FIG. 12.

FIG. 12 is a drawing showing an example of the meta information in the data source 2.

As shown in FIG. 12, the meta information includes storage regions for “table name”, “column name”, and “format”.

The storage region for the “table name” in the meta information stores therein, for example, tables (data) such as a “production performance table” and an “equipment state table”.

The storage region for the “column name” in the meta information stores therein, for example, column names such as “workpiece ID”, “step start time”, “step end time”, “step”, “equipment name”, “equipment state”, “state start time”, and the like.

The storage region for the “format” in the meta information stores therein, for example, a data format such as “character string”, “date/time”, “numerical value”, or the like, with respect to each of the column names listed under “column name”

In this situation, when the data is a CSV file or the like, the meta information acquisition unit 101 may acquire a list of file names or header names in each file as the meta information.

Further, when the meta information is of the equipment 3, the meta information acquisition unit 101 may acquire a list of functions (interfaces) that are executable by the equipment and arguments, as shown in FIG. 13.

FIG. 13 is a drawing showing an example of the meta information of the equipment 3.

As shown in FIG. 13, the meta information includes storage regions for “equipment”, “function name”, and “argument”.

It is observed that the storage region for the “equipment” in the meta information of the equipment 3 obtained by the meta information acquisition unit 101 stores therein, for example, equipment such as “machine tool A-1”, “machine tool A-2”, and so on.

It is observed that the storage region for the “function name” in the meta information of the equipment 3 stores therein, for example, functions such as “machining program, backup”, “start machining”, “door open/close function”, and the like.

It is observed that the storage region for the “argument” in the meta information of the equipment 3 stores therein, for example, arguments such as a “start time” with respect to each of the functions in the “function name”.

In this situation, when the meta information is of the equipment 3, the meta information acquisition unit 101 may acquire the types, file names, formats, and the like of the data that can be acquired from the equipment 3.

### <Configuration-Screen Auto-Creation Unit 102>

The configuration-screen auto-creation unit 102 reads, from the storage unit 20, the template information 200 selected by the screen creator who generates (customizes) the work screen by using the template information 200. Based on the template screen 201, the configuration items 202, and the template behavior 203 that are defined, in advance, in the read template information 200, the configuration-screen auto-creation unit 102 creates a configuration screen for inputting configuration information used by the screen creator for customizing (creating) the work screen, with respect to the entire work screen or each of the configuration items respectively corresponding to the constituent elements. The configuration-screen auto-creation unit 102 displays the created configuration screen on the output device 40. In this manner, the screen creator is able to customize (create) the work screen via the configuration screen created by the configuration-screen auto-creation unit 102.

Further, when the screen creator has selected existing configuration information 210 created by the configuration-information creation unit 103 (explained later), the configuration-screen auto-creation unit 102 may read the selected configuration information 210 from the storage unit 20. The configuration-screen auto-creation unit 102 may read, from the storage unit 20, the template information 200 corresponding to the template ID associated with the configuration information 210. Based on the existing configuration information 210 and the template information 200 that have been read, the configuration-screen auto-creation unit 102 may create a configuration screen for inputting a configuration to be used by the screen creator to edit the already-created configuration information (screen), with respect to each of the configuration items. In this manner, the screen creator is able to customize (edit) the existing configuration information 210 (screen), via the configuration screen created by the configuration-screen auto-creation unit 102.

Furthermore, based on the permission information in the user information 220 and the edit permission information configured in the template information 200, the configuration-screen auto-creation unit 102 may create a configuration screen that includes only one or more configuration items on which editing operations are permitted depending on users.

Next, examples will be explained in which the created configuration screen (a) is a configuration screen for the factory monitoring screen; and (b) is a configuration screen for the production performance registration screen. In this situation, in the example of (a) the factory monitoring screen, an example will be explained in which the screen creator selects the template information 200, so as to newly create a configuration screen. Further, in the example of (b) the production performance registration screen, an example will be explained in which the screen creator selects the existing configuration information 210, so as to create a configuration screen for editing the existing configuration information 210 that was selected. Further, the configuration-screen auto-creation unit 102 is also capable of creating configuration screens for screens other than the factory monitoring screen and the production performance registration screen, in the same manner as the factory monitoring screen and the production performance registration screen.

### (a) Regarding the Configuration Screen for the Factory Monitoring Screen

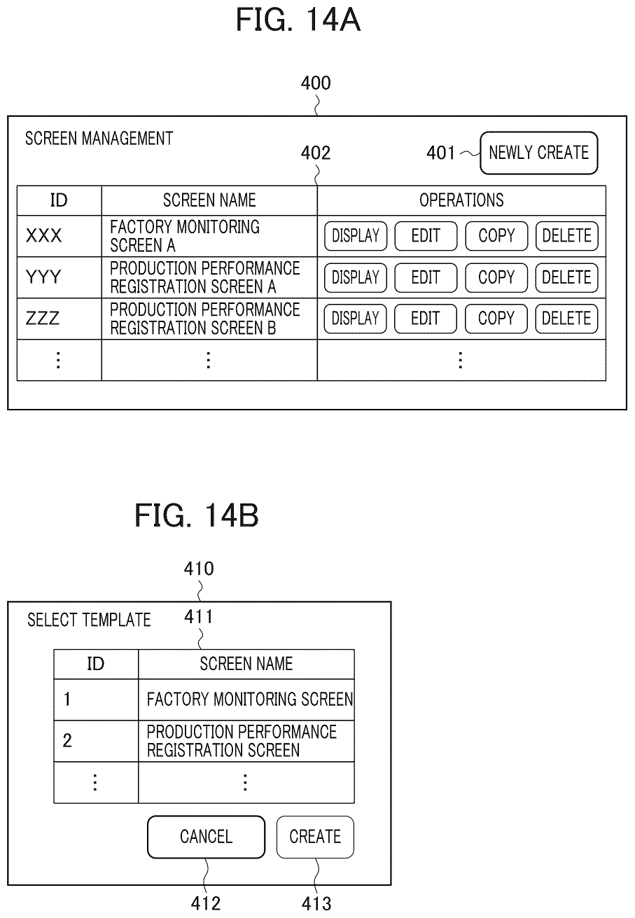

More specifically, for example, upon receipt of an instruction to select the template information 200 from the screen creator via the input device 30, the configuration-screen auto-creation unit 102 displays, on the output device 40, a screen management screen 400 including a NEWLY CREATE button 401 created by the configuration information management unit 105 (explained later) and a configuration information table 402 of the existing configuration information 210, as shown in FIG. 14A. In this situation, the configuration information table 402 includes IDs of the pieces of configuration information 210, the name of a work screen to be created based on each of the pieces of configuration information 210, and operation buttons corresponding to the pieces of configuration information 210. Further, the operation buttons include a display button used for causing the work screen to be displayed based on the configuration information 210; an edit button used for causing a configuration screen for editing the configuration information 210 to be displayed; a copy button used for copying the configuration information 210; and a delete button used for deleting the configuration information 210.

As a result of the NEWLY CREATE button 401 being pressed on the screen management screen 400 based on an input operation performed by the screen creator via the input device 30, the configuration-screen auto-creation unit 102 causes a template selection screen 410 shown in FIG. 14B to be displayed on the output device 40. In this situation, as shown in FIG. 14B, the template selection screen 410 includes a template information table 411 of the template information 200, a CANCEL button 412, and a CREATE button 413.

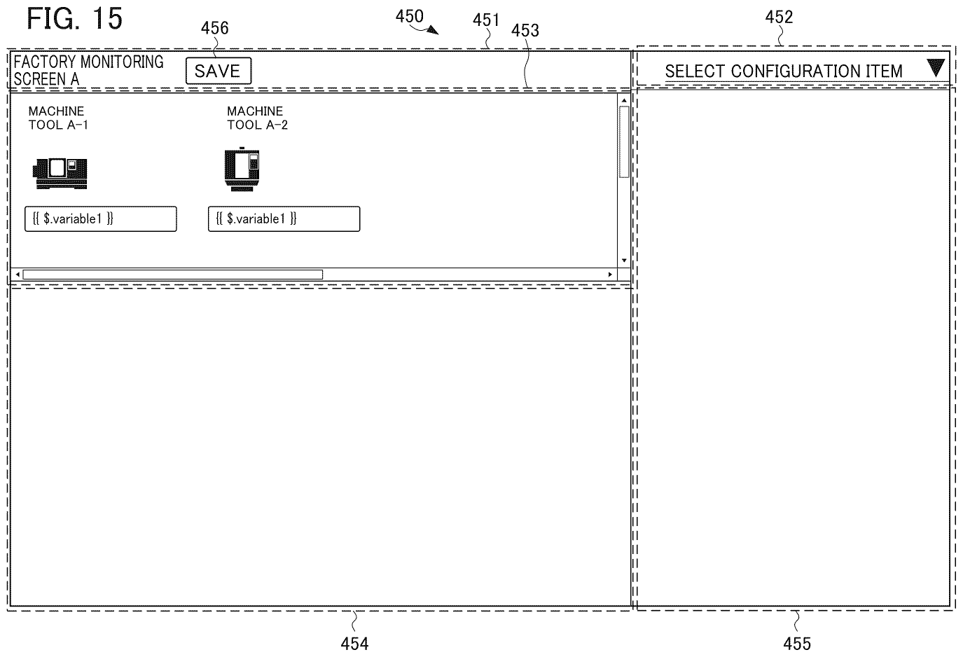

When the CREATE button 413 is pressed after selecting the template information 200 in the row corresponding to the “factory monitoring screen” identified with the ID “1” in the template information table 411 on the template selection screen 410, based on an input operation performed by the screen creator via the input device 30, the configuration-screen auto-creation unit 102 creates a configuration screen 450 for the factory monitoring screen shown in FIG. 15.

FIG. 15 is a drawing showing an example of the configuration screen 450 for the factory monitoring screen.

As shown in FIG. 15, the created configuration screen 450 includes, for example, five display regions 451 to 455. The display region 451 displays an input box for inputting an arbitrary screen name (a configuration information name) such as the “factory monitoring screen”; and a SAVE button 456 for saving a configuration value or the like configured on the configuration screen 450. Further, the display region 452 displays a pull-down menu used for selecting one of the configuration item groups from among the list of the configuration item groups (e.g., the entire screen or the configuration shared by the equipment icons in FIG. 5). Further, the display region 453 displays, as a default value, the template screen 201 in FIG. 4 from among the template information 200 on the factory monitoring screen selected on the template selection screen 410 in FIG. 14A. Further, as explained later, based on the accompaniment information of the usage data 202b of the constituent elements (or the entire screen), with respect to either the configuration item group selected within the display region 452 or the template screen 201 selected within the display region 453, the display region 454 displays an interface used for establishing a configuration related to the usage data. Further, as explained later, based on the accompaniment information of the appearances/behaviors 202a of the constituent elements (or the entire screen), with respect to either the configuration items group selected within the display region 452 or the template screen 201 selected within the display region 453, the display region 455 displays an interface used for establishing a configuration of each of the configuration items.

For example, based on an input operation performed by the screen creator who creates (customizes) the work screen by using the template information 200, the equipment icon A (the constituent element 230b in FIG. 4) representing the “machine tool A-1” is selected on the configuration screen 450 in FIG. 15, from within the template screen 201 displayed in the display region 453. As a result, the configuration screen 450 causes a configuration screen related to the usage data 202b for the selected equipment icon A (the constituent element 230b) to be displayed in the display region 454 and further causes a configuration screen related to the appearances/behaviors 202a for the selected equipment icon A (the constituent element 230b) to be displayed in the display region 455. In this situation, based on an input operation performed by the screen creator, the configuration screen 450 may realize the same display also when the “equipment icon A” is selected from the pull-down menu for the configuration item group displayed in the display region 452.

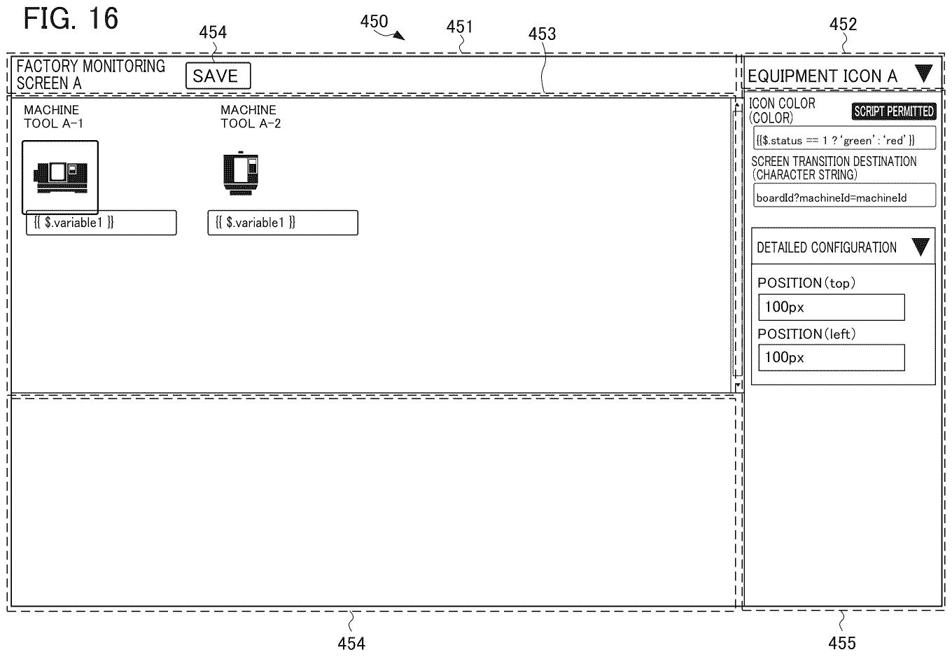

FIG. 16 is a drawing showing an example of the configuration screen 450 observed upon selecting the equipment icon (the constituent element 230b). To the other constituent elements 230a and 230c to 230f, the same feature as in the example of the constituent element 230b applies.

For example, when the “equipment icon A” is selected from the pull-down menu of the configuration item group in the display region 452, the configuration screen 450 realizes a display in the display region 453 in which the selected equipment icon (the constituent element 230b) is enclosed in a solid-line rectangular frame.

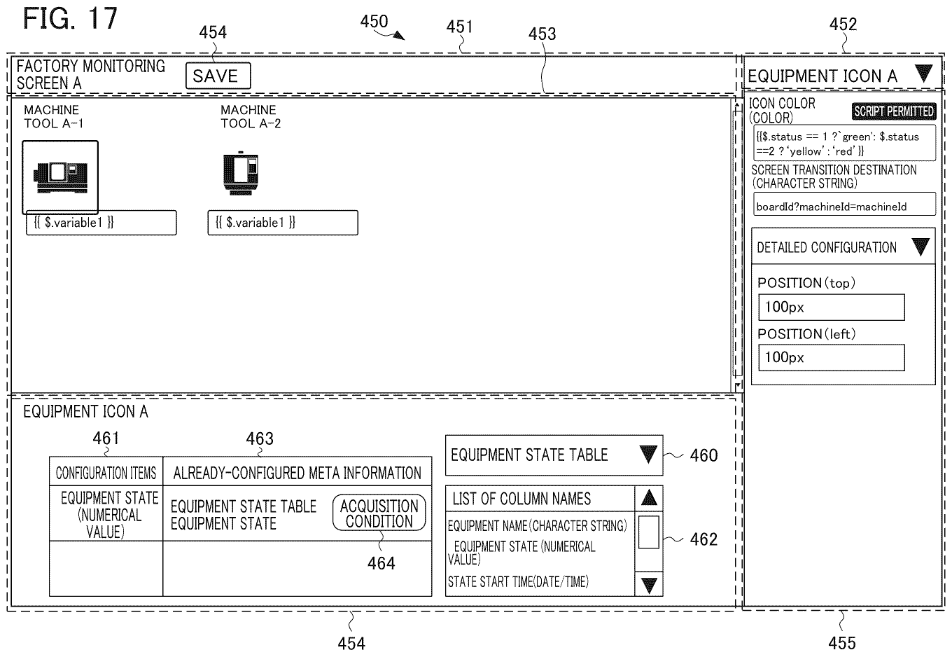

As shown in FIG. 16, based on the accompaniment information of the appearances/behaviors 202a, the configuration screen 450 displays the interface for the configuration items such as an icon color, the display position, and the like of the selected equipment icon A (the constituent element 230b). In other words, for example, as being triggered by the equipment icon A being selected from the pull-down menu for the configuration item group in the display region 452, the configuration screen 450 displays a text box for inputting configuration values (a character string, a numerical value, a script, etc.) of an icon color, a screen transition destination, and the like, based on the accompaniment information of the appearances/behaviors 202a in FIG. 5. For example, on the configuration screen 450 in FIG. 16, the text box for the icon color and the screen transition destination displays the default values of the appearances/behaviors 202a in FIG. 5. After that, when the screen creator has added a condition where, when the status of the equipment icon A (the constituent element 230b) is “2”, the equipment icon A (the constituent element 230b) is to be colored “yellow”, the script for the configuration item of the icon color will be edited, as shown in FIG. 17.

In this manner, the screen creator is able to establish the configurations related to the appearances/behaviors 202a, while referencing the displayed default values (the configuration values) and is thus able to save the trouble of inputting configuration values for any configuration items that are allowed to remain with the default values,

Further, on the configuration screen 450 in FIG. 16, among the detailed item configurations for the appearances/behaviors 202a in FIG. 5, the position (top) and the position (left) of the configuration items configured to be “true” may be integrated together and displayed as a detailed item configuration, for example, so as to be deployable in accordance with an operation (pressing) performed by the screen creator on a section corresponding to the detailed configuration. FIG. 16 shows the configuration screen 450 observed when the detailed configuration has been deployed.

Further, as being triggered by the “equipment icon A” being selected from the pull-down menu for the configuration item group in the display region 452, the configuration screen 450 displays, in the display region 454, an interface for the configuration item for the usage data corresponding to the selected equipment icon A (the constituent element 230b), based on the accompaniment information of the usage data 202b, as shown in FIG. 17. For example, on the configuration screen 450, the table name included in the meta information in FIG. 12 acquired by the meta information acquisition unit 101 is configured into a pull-down menu 460. Upon selection of the “equipment state table” from the pull-down menu 460 according to an input operation performed by the screen creator, the configuration screen 450 displays the column names and the formats in the selected table, as a column name list 462. Further, the configuration screen 450 displays a configuration item 461 corresponding to the “equipment icon A” selected from the pull-down menu for the configuration item group in the display region 452; and already-configured meta information 463 by which the column names are to be configured, through a drag-and-drop operation or the like, from the column name list 462 into the configuration item 461.

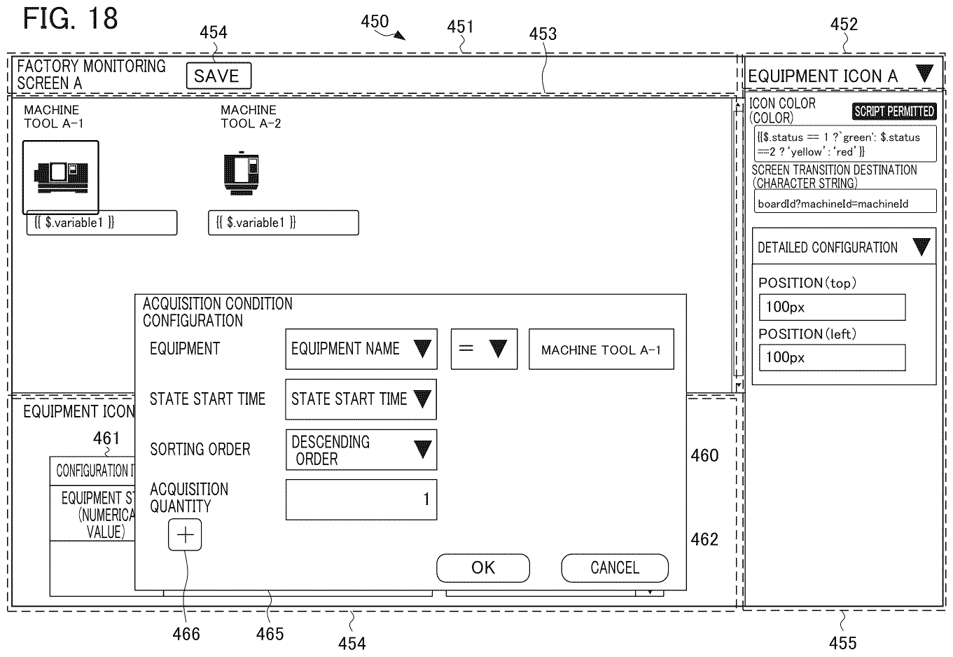

For example, when the column name of the “equipment state (the numerical value)” in the column name list 462 has been dragged and dropped into the configuration item 461 based on an input operation performed by the screen creator, the configuration screen 450 displays an ACQUISITION CONDITION button 464 used for configuring an acquisition condition for the data representing the “equipment state table/equipment state” configured in the already-configured meta information 463, according to the accompaniment information of the usage data 202b in the configuration items 202 for the constituent element 230b. After that, as being triggered by the ACQUISITION CONDITION button 464 being pressed based on an input operation performed by the screen creator, the configuration screen 450 realizes a modal display of an acquisition condition configuration screen 465, as shown in FIG. 18. For example, based on the “acquisition condition” in the accompaniment information for the usage data 202b in FIG. 6, the configuration screen 450 prompts the screen creator to configure the “equipment name” to be the “machine tool A-1” and further receives an input from the screen creator.

Further, based on the “acquisition condition” in the accompaniment information for the usage data 202b, the configuration screen 450 configures the configuration value of each of the configuration items with respect to the state start time, the sorting order, and the acquisition quantity, by using the default value. Further, the configuration value of each of the configuration items with respect to the state start time, the sorting order, and the acquisition quantity may be changed from the default value, based on an input operation performed by the screen creator.

Further, when an ADD button 466 is pressed through an input operation performed by the screen creator, the configuration screen 450 may add an acquisition condition. Further, besides “equal to (=)”, the accompaniment information for the usage data 202b may be configured, as the acquisition conditions, with “not equal to (≠)”, “including”, a larger/smaller relationship, an aggregate function in Structured Query Language (SQL), an acquisition quantity, and the like.

After the configuration (the editing of the screen) on the configuration screen 450 has been completed, the screen creator presses the SAVE button 456, so that the configuration-information creation unit 103 (explained later) creates the configuration information 210 shown in FIG. 10, for example, so as to be saved into the storage unit 20, based on what has been input on the configuration screen 450.

### (b) Regarding the Configuration Screen for the Production Performance Registration Screen

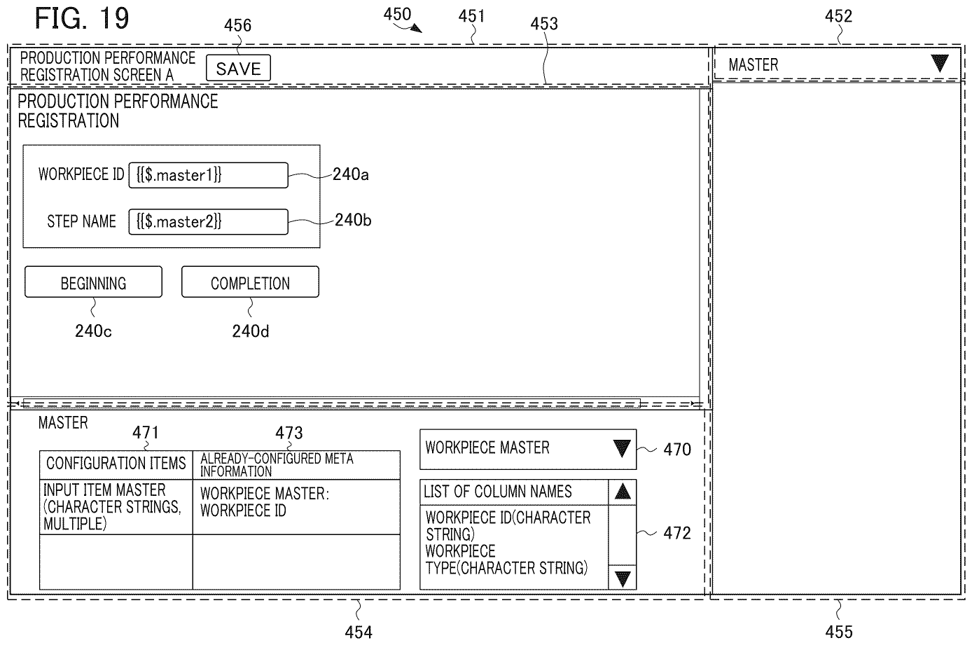

Upon receipt of an instruction to select the template information 200 from the screen creator via the input device 30, for example, the configuration-screen auto-creation unit 102 displays, on the output device 40, the screen management screen 400 in FIG. 14A created by the configuration information management unit 105 (explained later). When the EDIT button for the configuration information 210 is pressed with respect to the “production performance registration screen A” corresponding to the ID “YYY” on the screen management screen 400 based on an input operation performed by the screen creator via the input device 30, the configuration-screen auto-creation unit 102 reads the configuration information 210 from the storage unit 20. The configuration-screen auto-creation unit 102 reads, from the storage unit 20, the template information 200 corresponding to the template ID configured in the read configuration information 210. Based on the template information 200 and the configuration information 210 that were read, the configuration-screen auto-creation unit 102 creates the configuration screen 450 shown in FIG. 19 so as to be displayed on the output device 40.

FIG. 19 is a drawing showing an example of the configuration screen 450 for the production performance registration screen.

As shown in FIG. 19, the created configuration screen 450 displays, in the display region 453, for example, the template screen 201 for the production performance registration screen, based on the template information 200 read from the storage unit 20.

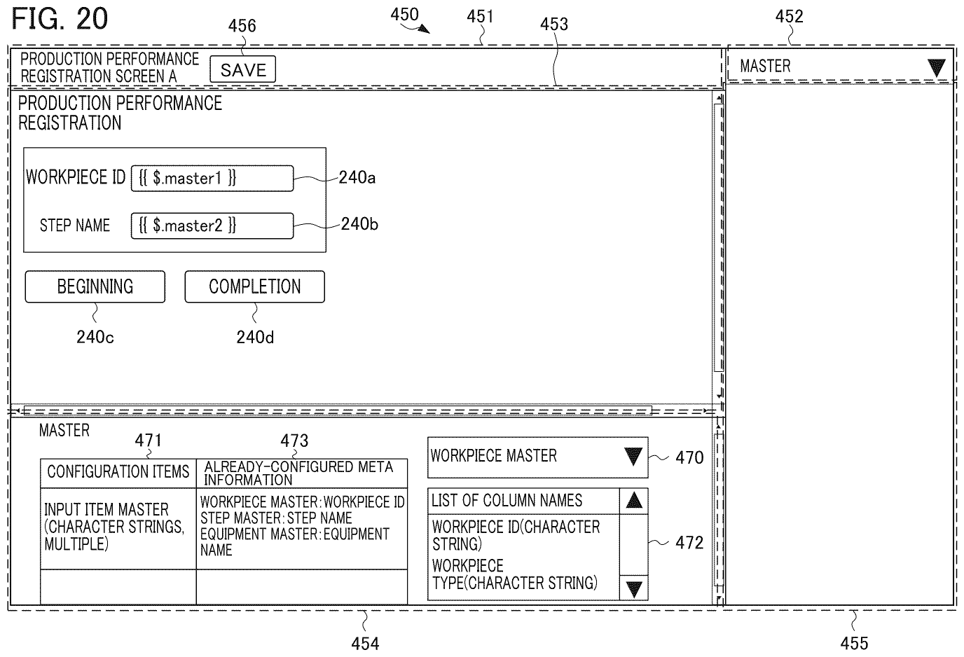

For example, when the “master” is selected from the pull-down menu in the display region 452, and a “workpiece master” is selected from a pull-down menu 470 in the display region 454, based on an input operation performed by the screen creator, the configuration screen 450 displays a column name list 472 of the meta information of the selected “workpiece master”. Further, the configuration screen 450 displays a configuration item 471 corresponding to the “workpiece master” and already-configured meta information 473 by which the column names are to be configured from the column name list 472 into the configuration item 471 through a drag-and-drop operation or the like. For example, as shown in FIG. 19, when the column name of the “workpiece ID (character string)” in the column name list 472 is dragged and dropped into the already-configured meta information 473 based on an input operation performed by the screen creator, “workpiece master: workpiece ID” is to be added. Further, on the configuration screen 450, as shown in FIG. 20, when the “step master” and the “equipment master” are each similarly selected from the pull-down menu 470 in the display region 454 based on an input operation performed by the screen creator, the “step name (character string)” and the “equipment name (character string)” are each dragged and dropped from the column name list 472 and configured into the already-configured meta information 473.

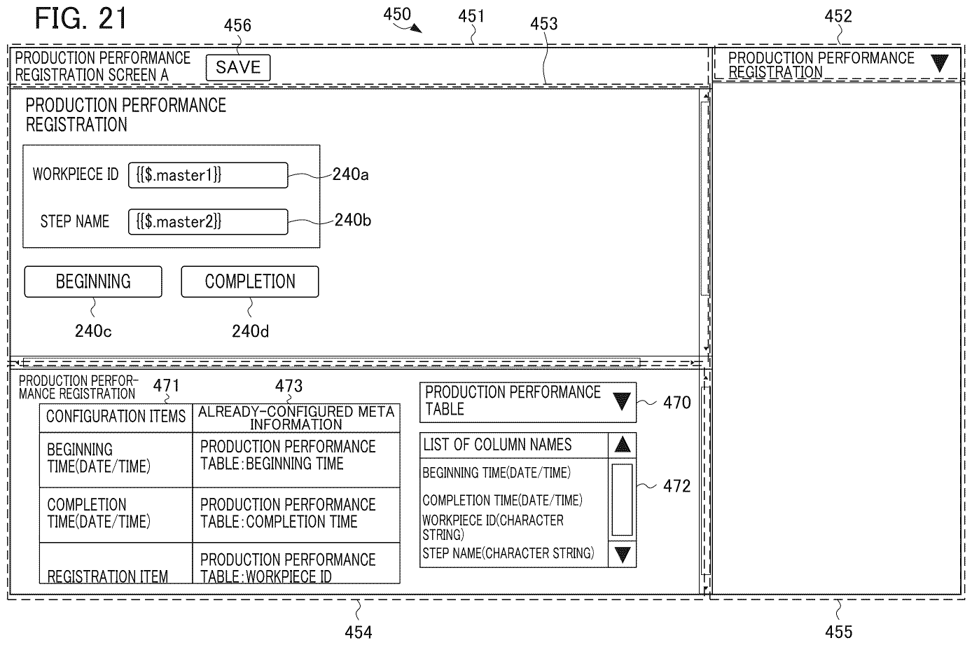

Next, for example, as shown in FIG. 21, when the “production performance registration” is selected from the pull-down menu in the display region 452 and the “production performance table” is selected from the pull-down menu 470 in the display region 454, based on an input operation performed by the screen creator, the configuration screen 450 displays the column name list 472 of the meta information of the selected “production performance table”. Similarly to the example of the “workpiece master”, on the configuration screen 450, based on an input operation performed by the screen creator, the “beginning time (date/time)” is dragged and dropped and configured into the already-configured meta information 473, from the column name list 472, as the “beginning time (date/time)” in the configuration item 471. Further, on the configuration screen 450, based on an input operation performed by the screen creator, the “completion time (date/time)” is dragged and dropped and configured into the already-configured meta information 473, from the column name list 472, as the “completion time (date/time)” in the configuration item 471. Further, on the configuration screen 450, based on an input operation performed by the screen creator, the “workpiece ID (character string)”, the “step name (character string)”, and “equipment name (character string)” may be dragged and dropped and configured into the already-configured meta information 473, from the column name list 472, as the “registration item (character strings, multiple)” in the configuration item 471, as partially shown in the drawing.

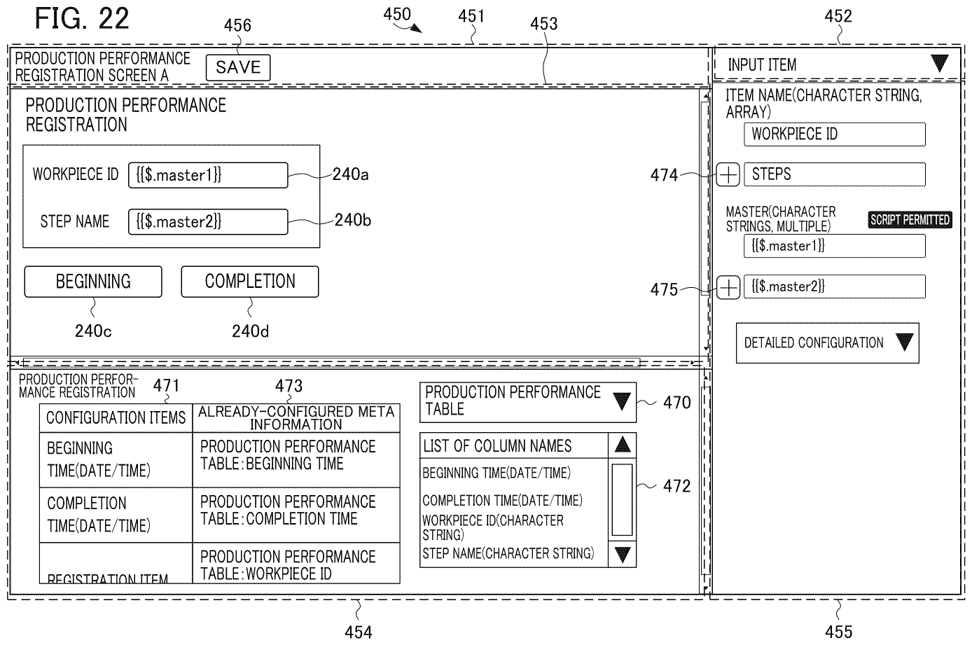

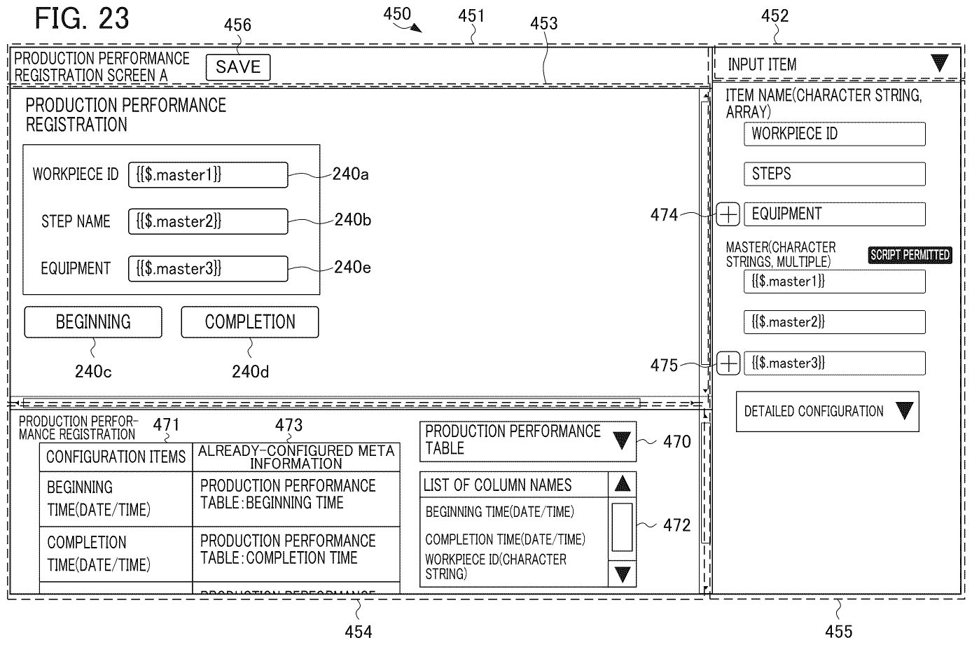

Further, when the “input item” is selected from the pull-down menu in the display region 452 based on an input operation performed by the screen creator, the configuration screen 450 displays, in the display region 455, an interface of the configuration items of the item name, the master, and the detailed configuration included in the selected input item, as shown in FIG. 22, based on the accompaniment information of the appearances/behaviors 202a in FIG. 8. In other words, for example, as being triggered by the “input item” being selected from the pull-down menu for the configuration item group in the display region 452, for example, the configuration screen 450 displays a text box for inputting configuration values (a character string, a script, etc.) of the item name, the master, and the like, based on the accompaniment information of the appearances/behaviors 202a in FIG. 8. Further, the configuration screen 450 may display ADD buttons 474 and 475 for the item name and the master, so as to add configuration values of the item name and the master, based on an input operation performed by the screen creator, as shown in FIG. 23. As a result, the screen creator is able to add the constituent element 240e of the “equipment” in the display region 453.

Further, the screen creator is able to establish configurations related to the appearances/behaviors 202a and the usage data 202b, by referencing the default values (the configuration values) being displayed. Further, the screen creator is able to save the trouble of inputting configurations with respect to any configuration items that do not need to be changed from the selected configuration information.

After the configuration (editing of the screen) is completed on the configuration screen 450, the screen creator presses the SAVE button 456, so that the configuration-information creation unit 103 (explained later) creates the configuration information 210 based on what has been edited on the configuration screen 450 and further updates the configuration information 210 stored in the storage unit 20.

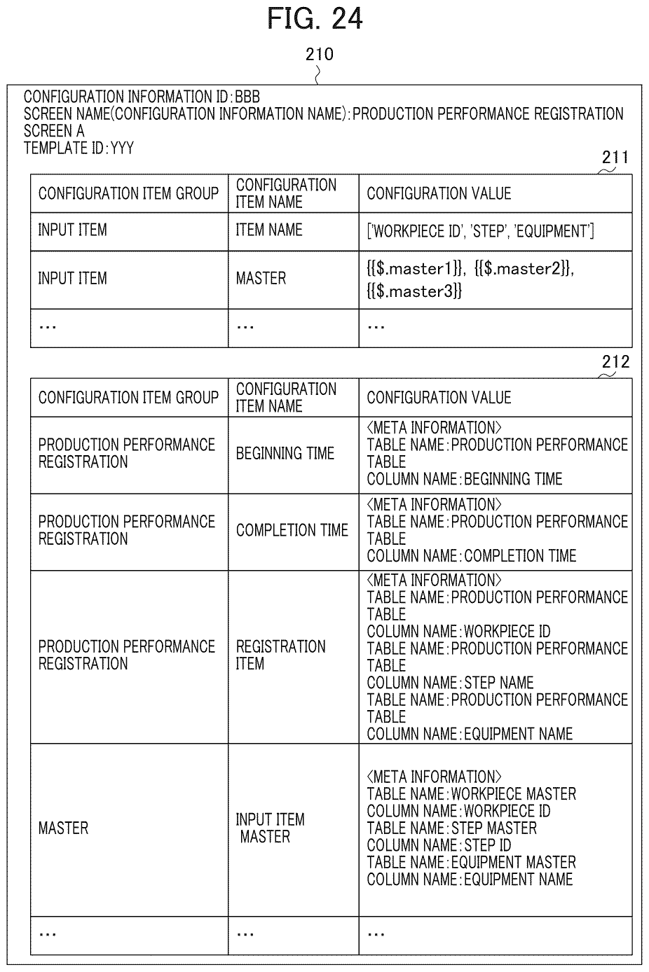

FIG. 24 is a drawing showing an example of the configuration information 210 for the production performance registration screen that has been updated.

As shown in FIG. 24, the configuration information 210 includes a configuration information ID that was configured when the information was newly created, a screen name, and a template ID of the template information 200 to be used.

Further, the configuration information 210 includes a table 211 for storing therein the configuration item groups of which the default values were changed by the screen creator among the appearances/behaviors 202a in FIG. 8, as shown in FIGS. 20 to 23, as well as configuration item names and post-change configuration values. Further, the configuration information 210 includes a table 212 for storing therein the configuration item groups of which the default values were changed by the screen creator among the usage data 202b in FIG. 9, as well as configuration item names and post-change configuration values.

### <Configuration-Information Creation Unit 103>

Based on information about the configuration items configured on the configuration screen 450, the configuration-information creation unit 103 creates the configuration information 210.

More specifically, for example, when the SAVE button 456 on the configuration screen 450 is pressed by the screen creator, the configuration-information creation unit 103 appends, to the configuration information 210, a configuration information ID (an automatically-generated UUID or the like, if the configuration information was newly created), a screen name, a template ID of the template information 200 to be used, as shown in FIG. 10 or FIG. 24. The configuration-information creation unit 103 creates, so as to be added to the configuration information 210, the tables 211 and 212 indicating the configuration item groups for the configuration items of which the default values were changed by the screen creator, among the appearances/behaviors 202a and the usage data 202b in the configuration items 202 of the template information 200 to be used, as well as configuration item names and post-change configuration values. The configuration-information creation unit 103 stores (updates) the created configuration information 210 into the storage unit 20.

### <Screen Auto-Creation Unit 104>

For example, upon receipt of an instruction to select a work screen from the screen user via the input device 30, the screen auto-creation unit 104 displays, on the output device 40, the screen management screen 400 shown in FIG. 14A created by the configuration information management unit 105 (explained later). When a DISPLAY button is pressed for the work screen such as the “factory monitoring screen A” corresponding to the ID “XXX” on the screen management screen 400, based on an input operation performed by the screen user, the screen auto-creation unit 104 reads, from the storage unit 20, the configuration information 210 for the selected work screen, based on an instruction from the configuration information management unit 105 (explained later). The screen auto-creation unit 104 reads, from the storage unit 20, the template information 200 corresponding to the template ID configured in the read configuration information 210. The screen auto-creation unit 104 creates a work screen as a screen related to manufacturing, based on the template information 200 and the configuration information 210 that were read. In this situation, based on the permission information in the user information 220 and the usage permission information in the template information 200, the screen auto-creation unit 104 may create a work screen that includes only one or more configuration items on which operations are permitted depending on users.

The screen auto-creation unit 104 is able to apply the created work screen to a display device (not shown), as a screen related to the manufacturing. For example, the screen creation device 1 may be linked to a work system (not shown) so that the generated screen is provided for a work system (not shown).

### <Configuration Information Management Unit 105>

The configuration information management unit 105 manages the configuration information 210 created by the configuration-information creation unit 103.

More specifically, for example, upon receipt of an instruction to display the configuration information 210 from the user via the input device 30, the configuration information management unit 105 reads the configuration information 210 that is displayable with respect to each user, based on the user information 220 among the configuration information 210 stored in the storage unit 20. The configuration information management unit 105 displays, on the output device 40, the screen management screen 400 shown in FIG. 14A, which is a list of pieces of configuration information 210 that have been read.

When the DISPLAY button is pressed by the user, the configuration information management unit 105 outputs the selected configuration information 210 to the screen auto-creation unit 104. Based on the configuration information 210 and the corresponding template information 200, the screen auto-creation unit 104 creates a work screen and displays the created work screen on a display device (not shown). Further, when the EDIT button is pressed by the user, the configuration information management unit 105 outputs the selected configuration information 210 to the configuration-screen auto-creation unit 102. The configuration-screen auto-creation unit 102 creates the configuration screen 450 for the selected configuration information 210, so as to be displayed on the output device 40. Further, when a COPY SCREEN button was pressed by the user, the configuration information management unit 105 copies the selected configuration information 210 and stores the copied configuration information 210 into the storage unit 20 after assigning a new configuration information ID thereto. Further, when a DELETE button was pressed by the user, the configuration information management unit 105 deletes the selected configuration information 210 from the storage unit 20.

In this situation, based on the permission information in the user information 220, the usage permission information and/or the edit permission information in the template information 200, for example, the configuration information management unit 105 may control whether or not it is permitted to perform operations (display, edit, copy, and delete) on each of the screens, on the screen management screen 400 in FIG. 14A. For example, based on the user information 220, the configuration information management unit 105 may cause the buttons for the operations that are not permitted with respect to each user, to be in a non-display state, be grayed out, or the like.

### <User Information Management Unit 106>

The user information management unit 106 manages the user information 220.

More specifically, the user information management unit 106 may manage, in the user information 220, for example, permission information related to the operations permitted to each user with respect to each screen (the configuration information 210). With this arrangement, as explained above, based on the permission information in the user information 220, the usage permission information and/or the edit permission information in the template information 200, for example, the configuration information management unit 105 may control whether it is permitted to perform the operations (display, edit, copy, and delete) on each screen, on the screen management screen 400 in FIG. 14A. For example, the configuration information management unit 105 may cause the buttons for the operations that are not permitted, to be in a non-display state, be grayed out, or the like.

Further, the user information management unit 106 may manage, in the user information 220, permission information related to a configuration editing operation with respect to each of the configuration items in the template information 200. With this arrangement, based on the permission information in the user information 220 or the usage permission information or the edit permission information in the template information 200 (or the configuration information 210), the configuration-screen auto-creation unit 102 may control whether or not editing of the configuration items on the configuration screen 450 is permitted. For example, the configuration-screen auto-creation unit 102 may cause the configuration items of which the editing is not permitted to be in a non-display state, be grayed out, or the like.

Alternatively, the screen auto-creation unit 104 may create a work screen based on the permission information in the user information 220 or the usage permission information in the template information 200 (or the configuration information 210). In other words, even if the work screen is the same being a factory monitoring screen or a production performance registration screen, the configuration items to be displayed on the work screen may be different among different users. With this arrangement, even if the work screen (the configuration information 210) is the same, it is possible to enable each user to monitor a different piece of equipment 3.

### <Creation Processes Performed by the Screen Creation Device 1>

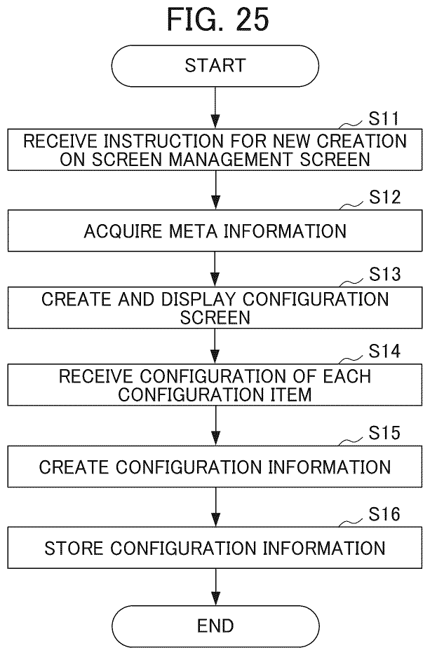

Next, a flow in creation processes performed by the screen creation device 1 will be explained, with reference to FIGS. 25 to 27. In the following sections, the creation processes performed by the screen creation device 1 will be explained with (a) an example in which the configuration information 210 is to be newly created; (b) an example in which the existing configuration information 210 is to be edited; and (c) an example in which the work screen is to be displayed.

(a) the Example in which the Configuration Information 210 is to be Newly Created

FIG. 25 is a flowchart for explaining a creation process performed by the screen creation device 1, when the configuration information 210 is to be newly created. The flow in the present example is executed every time an instruction to newly create a work screen is received from the screen creator.

In step S11, the configuration-screen auto-creation unit 102 receives a new creation instruction as a result of the NEWLY CREATE button 401 being pressed on the screen management screen 400 by the screen creator via the input device 30. The configuration-screen auto-creation unit 102 receives a selection of the template information 200 for the work screen to be newly created by the screen creator, in the template information table 411 on the template selection screen 410.

In step S12, the meta information acquisition unit 101 acquires the meta information of the data in the data source 2, the equipment 3, and the like, from the data source 2, the equipment 3, and the like.

In step S13, the configuration-screen auto-creation unit 102 creates the configuration screen 450 based on the template information 200 of the work screen selected in step S11, so as to be displayed on the output device 40.

In step S14, based on an input operation performed by the Screen creator, the configuration-screen auto-creation unit 102 receives, on the configuration screen 450, configurations with respect to each of the appearances/behaviors 202a and the usage data 202b in the configuration items 202.

In step S15, for example, as being triggered by the screen creator pressing the SAVE button 456 on the configuration screen 450, the configuration-information creation unit 103 creates the configuration information 210 to which the newly-created configuration information ID, a screen name, a template ID of the template information 200 to be used are appended. Further, the configuration-information creation unit 103 creates, so as to be configured into the configuration information 210, the tables 211 and 212 indicating the configuration item groups for the configuration items of which the default values were changed, among the appearances/behaviors 202a and the usage data 202b in the configuration items 202 in the template information 200, as well as configuration item names and post-change configuration values.

In step S16, the configuration-information creation unit 103 stores the configuration information 210 created in step S15 into the storage unit 20.

(b) the Example in which the Existing Configuration Information 210 is to be Edited

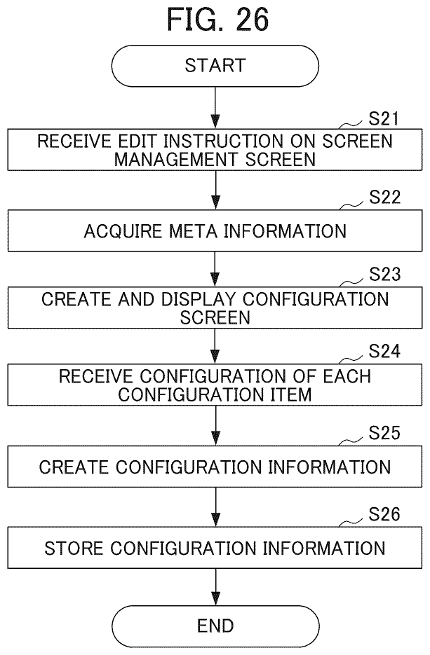

FIG. 26 is a flowchart for explaining a creation process performed by the screen creation device 1, when the existing configuration information 210 is to be edited. The flow in the present example is executed every time an instruction to edit existing configuration information 210 is received from the screen creator.

In this situation, because the processes in step S22, step S24, and step S25 are the same as the processes in step S12, step S14, and step S15 in FIG. 25, explanations thereof will be omitted.

In step S21, as being triggered by the EDIT button for the work screen displayed on the screen management screen 400 being pressed based on an input operation performed by the screen creator, the configuration-screen auto-creation unit 102 receives an instruction to edit the configuration information 210.

In step S23, the configuration-screen auto-creation unit 102 reads, from the storage unit 20, the configuration information 210 for the work screen selected in step S11. The configuration-screen auto-creation unit 102 reads, from the storage unit 20, the template information 200 identified with the template ID configured in the read configuration information 210. Based on the template information 200 and the configuration information 210 that were read, the configuration-screen auto-creation unit 102 creates the configuration screen 450, so as to be displayed on the output device 40.

In step S26, the configuration-information creation unit 103 stores the configuration information 210 created in step S25 into the storage unit 20, so as to make an update.

(c) the Example in which a Work Screen is to be Displayed by Selecting the Configuration Information 210

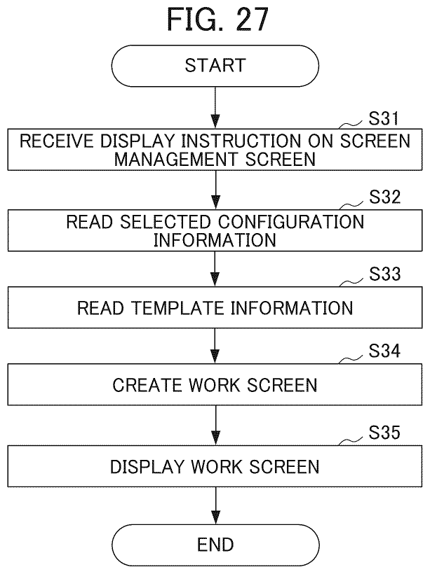

FIG. 27 is a flowchart for explaining a creation process performed by the screen creation device 1, when a work screen is to be displayed by selecting the configuration information 210. The flow in the present example is executed every time the screen user selects configuration information 210 and a display instruction is received.

In step S31, as being triggered by a DISPLAY button for the work screen displayed on the screen management screen 400 being pressed based on an input operation performed by the screen user, the screen auto-creation unit 104 receives an instruction to display the work screen.

In step S32, the screen auto-creation unit 104 reads, from the storage unit 20, the configuration information 210 of the selected work screen.

In step S33, the screen auto-creation unit 104 reads, from the storage unit 20, the template information 200 corresponding to the template ID configured in the configuration information 210 read in step S32.

In step S34, the screen auto-creation unit 104 creates the work screen based on the template information 200 read in step S33 and the configuration information 210 read in step S32.

In step S35, the screen auto-creation unit 104 displays, on a display device (not shown), the work screen created in step S34.

As explained above, the screen creation system SYS according to the one embodiment is capable of presenting, to the template creator, the screen that includes the most suitable configuration items corresponding to the method for using the template screen and is also capable of enabling the screen creator, who will employ the template to create (customize) the work screen, to easily create the screen suited to each work site by configuring the template screen.

Further, from the single template, the screen creator is able to easily create a plurality of screens having mutually-different data to be displayed, layouts, and/or behaviors. For example, even the screen is for doing the same work, it is possible to easily create a work screen that is optimized for the needs of each user.

Further, the screen creation system SYS is capable of easily creating the screen on which the data visible to each user is restricted or added and is thus capable of managing the screen that is displayable for each user among the plurality of created screens.

Further, because the created screen has the ID, it is possible to easily realize the transition between the screens, by designating the ID as a configuration item at the link destination.

The one embodiment has thus been explained; however, the Screen creation system SYS is not limited to the embodiment described above, and includes modifications, improvements, and the like within the capability to achieve the object.

### First Modification Example

In the one embodiment, the screen creation device 1 is a device different from the display device that displays the screen related to the manufacturing; however, possible embodiments are not limited to this example. For example, the screen creation device 1 may include the display device (not shown).

### Second Modification Example

Further, for example, in the one embodiment, the configuration-screen auto-creation unit 102 creates the configuration screen 450 in Japanese, while the configuration-information creation unit 103 creates the configuration information 210 in Japanese, and the screen auto-creation unit 104 creates the display screen in Japanese; however, possible embodiments are not limited to this example.

For example, the configuration-screen auto-creation unit 102 may create the configuration screen 450 that establishes a configuration for each of different languages (e.g., Japanese, English, and Chinese, etc.), so that the configuration-information creation unit 103 creates the configuration information 210 in each language based on the information configured on the configuration screen 450, and the screen auto-creation unit 104 creates the display screen corresponding to each language based on the configuration information 210.

It is possible to realize each of the functions included in the screen creation system SYS in the one embodiment, by using hardware, software, or a combination of these. In this situation, being realized by the software denotes being realized as a result of a computer reading and executing a program.

The program may be stored by using a non-transitory computer readable medium of any of various types so as to be supplied to the computer. Examples of the non-transitory computer readable medium include tangible storage media of various types. Examples of the non-transitory computer readable medium include a magnetic recording medium (e.g., a flexible disk, a magnetic tape, a hard disk drive), an opto-magnetic recording medium (e.g., an opto-magnetic disc), a CD-ROM (Read Only Memory), a CD-R, a CD-R/W, a semiconductor memory (e.g., a mask ROM, a PROM (programmable ROM), an EPROM (Erasable PROM), a flash ROM, a RAM)). Further, the program may be supplied to the computer via a transitory computer readable medium of any of various types. Examples of the transitory computer readable medium include electrical signals, optical signals, and electromagnetic waves. The transitory computer readable medium is able to supply the program to the computer via a wired communication path such as a wiring, an optical fiber, etc. or a wireless communication path.

In this situation, the steps describing the program recorded on the recording medium include the processes that are chronologically performed according to the sequential order thereof, needless to say, as well as processes that are performed in parallel or individually, while not necessarily being processed chronologically.

The present disclosure has thus been explained in detail; however, the present disclosure is not limited to the individual embodiments described above. It is possible to apply various types of additions, substitutions, changes, and partial deletions to the embodiment, without departing from the gist of the present disclosure or without departing from the scope of the present disclosure derived from what is set forth in the claims and equivalents thereof. Further, the embodiments may be carried out in combination. For example, in the embodiment described above, the sequential order of the operations and the sequential order of the processes are merely examples, and possible embodiments are not limited to those examples. Further, the same applies when numerical values or mathematical formula are used in the descriptions of the above embodiments.

In relation to the embodiments and the modification examples described above, the following supplements are further disclosed.

### (Supplement 1)

A screen creation device (1) includes: a configuration-screen auto-creation unit (102) configured to create a configuration screen (450) for configuring each of configuration items defined in pre-created template information (200) for a display screen; a configuration-information creation unit (103) configured to create configuration information based on information for each of the configuration items configured on the configuration screen (450); and a screen auto-creation unit (104) configured to create a display screen based on the template information (200) and the configuration information (210) created by the configuration-information creation unit (103).

### (Supplement 2)

The configuration-screen auto-creation unit (102) creates the configuration screen (450) for editing the configuration information (210) created by the configuration-information creation unit (103), and the configuration-information creation unit (103) creates the configuration information (210) based on information edited on the configuration screen (450).

### (Supplement 3)

The configuration item (202) is related to at least one selected from among usage data, a behavior, and an appearance.

### (Supplement 4)

The template information (200) includes the configuration item (202), a template screen (201), and a template behavior (203).

### (Supplement 5)

The screen creation device (1) according to Supplement 1 or 2 further includes: a meta information acquisition unit (101) configured to acquire one or both of meta information of usage data and meta information of equipment. The configuration-screen auto-creation unit (102) creates the configuration screen (450) for configuring the configuration information (210) based on the meta information acquired by the meta information acquisition unit (101); and the configuration-information creation unit (103) creates the configuration information (210) based on information configured on the configuration screen (450).

### (Supplement 6)

The display screen is a screen related to manufacturing.

### (Supplement 7)

The screen creation device (1) according to Supplement 1 or 2 further includes a template creation unit (100) configured to create the template information (200).

### (Supplement 8)

The screen creation device (1) according to Supplement 1 or 2 further includes a configuration information management unit (105) configured to manage the configuration information (210) created.

### (Supplement 9)

The screen creation device (1) according to Supplement 8, further including a user information management unit (106) configured to manage user information (220).

### (Supplement 10)

Based on the user information (220), the configuration information management unit (105) controls an operation performed by each user on the configuration information (210).

### (Supplement 11)

The configuration-screen auto-creation unit (102) creates the configuration screen (450), based on the user information (220) and either the template information (200) or the configuration information (210); and the configuration-information creation unit (103) creates the configuration information (210) based on information edited on the configuration screen (450).

### (Supplement 12)

The screen auto-creation unit (104) creates the display screen based on the user information (220), the template information (200), and the configuration information (210).

### (Supplement 13)

The configuration-screen auto-creation unit (102) creates the configuration screen (450) on which the configuration item is configured for each of languages; the configuration-information creation unit (103) creates the configuration information (210) for each of the languages based on information configured on the configuration screen (450); and the screen auto-creation unit (104) creates the display screen corresponding to the languages.

### (Supplement 14)

A screen creation method is a screen creation method for causing a computer to function as a screen creation device (1) and includes: a selection step of selecting one of pieces of pre-created template information (200) for a display screen; a configuration-screen auto-creation step of creating a configuration screen (450) for configuring each of configuration items defined in the template information (200) selected; a configuration-information creation step of creating configuration information (210) based on information for each of the configuration items configured on the configuration screen (450); and a screen auto-creation step of creating the display screen based on the template information (200) selected and the configuration information (210) created.

### EXPLANATION OF REFERENCE NUMERALS

1 screen creation device
10 control unit
100 template creation unit
101 meta information acquisition unit
102 configuration-screen auto-creation unit
103 configuration-information creation unit
104 screen auto-creation unit
105 configuration information management unit
106 user information management unit
20 storage unit
200-1 to 200-m template information
201 template screen
202 configuration item
202a appearances/behaviors
202b usage data
203 template behavior
210-1 to 210-n configuration information
220 user information
2 data source
3 equipment
SYS screen creation system

1. A screen creation device comprising:
a configuration-screen auto-creation unit configured to create a configuration screen for configuring each of configuration items defined in pre-created template information for a display screen;
a configuration-information creation unit configured to create configuration information based on information for each of the configuration items configured on the configuration screen; and
a screen auto-creation unit configured to create the display screen based on the template information and the configuration information created by the configuration-information creation unit.

2. The screen creation device according to claim 1, wherein
the configuration-screen auto-creation unit creates the configuration screen for editing the configuration information created by the configuration-information creation unit, and
the configuration-information creation unit creates the configuration information based on information edited on the configuration screen.

3. The screen creation device according to claim 1, wherein
the configuration item is related to at least one selected from among usage data, a behavior, and an appearance.

4. The screen creation device according to claim 1, wherein
the template information includes the configuration item, a template screen, and a template behavior.

5. The screen creation device according to claim 1, further comprising:
a meta information acquisition unit configured to acquire one or both of meta information of usage data and meta information of equipment, wherein
the configuration-screen auto-creation unit creates the configuration screen for configuring the configuration information based on the meta information acquired by the meta information acquisition unit, and
the configuration-information creation unit creates the configuration information based on information configured on the configuration screen.

6. The screen creation device according to claim 1, wherein the display screen is a screen related to manufacturing.

7. The screen creation device according to claim 1, further comprising a template creation unit configured to create the template information.

8. The screen creation device according to claim 1, further comprising a configuration information management unit configured to manage the configuration information created.

9. The screen creation device according to claim 8, further comprising a user information management unit configured to manage user information.

10. The screen creation device according to claim 9, wherein
based on the user information, the configuration information management unit controls an operation performed by each user on the configuration information.

11. The screen creation device according to claim 9, wherein
the configuration-screen auto-creation unit creates the configuration screen, based on the user information and either the template information or the configuration information, and
the configuration-information creation unit creates the configuration information based on information edited on the configuration screen.

12. The screen creation device according to claim 9, wherein
the screen auto-creation unit creates the display screen based on the user information, the template information, and the configuration information.

13. The screen creation device according to claim 1, wherein
the configuration-screen auto-creation unit creates the configuration screen on which the configuration item is configured for each of languages,
the configuration-information creation unit creates the configuration information for each of the languages based on information configured on the configuration screen, and
the screen auto-creation unit creates the display screen corresponding to the languages.

14. A screen creation method for causing a computer to function as a screen creation device, the screen creation method comprising:
a selection step of selecting one of pieces of pre-created template information for a display screen;
a configuration-screen auto-creation step of creating a configuration screen for configuring each of configuration items defined in the template information selected;
a configuration-information creation step of creating configuration information based on information for each of the configuration items configured on the configuration screen; and
a screen auto-creation step of creating the display screen based on the template information selected and the configuration information created.
